(19) United States
(12) Patent Application Publication
(10) Pub. No.: US 2023/0121314 A1
(43) Pub. Date: Apr. 20, 2023

(54) METHOD AND USER EQUIPMENT FOR REPORTING UE CAPABILITY FOR SMALL DATA TRANSMISSION

(71) Applicant: FG Innovation Company Limited, Tuen Mun (HK)

(72) Inventors: HSIN-HSI TSAI, Taipei (TW); HENG-LI CHIN, Taipei (TW); MEI-JU SHIH, Taipei (TW)

(21) Appl. No.: 17/966,173

(22) Filed: Oct. 14, 2022

Related U.S. Application Data
(60) Provisional application No. 63/255,888, filed on Oct. 14, 2021.

(51) Int. Cl. H04W 8/22

(52) U.S. Cl. CPC H04W 8/22

(57) ABSTRACT

A method and a user equipment (UE) for reporting UE capability for small data transmission (SDT) are provided. The method includes: receiving, from a base station (BS), a UE capability enquiry message; setting, in response to receiving the UE capability enquiry message, a content of a UE capability information message to indicate whether the UE supports random access (RA)-SDT; and transmitting, to the BS, the UE capability information message after setting the content of the UE capability information message.

### CROSS-REFERENCE TO RELATED APPLICATION(S)

The present disclosure claims the benefit of and priority to U.S. Provisional Patent Application Ser. No. 63/255,888, filed on Oct. 14, 2021, entitled “RANDOM ACCESS PREAMBLES GROUP FOR SMALL DATA TRANSMISSION,” the contents of which are hereby incorporated fully by reference into the present disclosure for all purposes.

### FIELD

The present disclosure is related to wireless communication and, more particularly, to a method and a user equipment (UE) for reporting UE capability for small data transmission (SDT) in the next generation wireless communication networks.

### BACKGROUND

Various efforts have been made to improve different aspects of wireless communication for cellular wireless communication systems, such as 5G New Radio (NR), by improving data rate, latency, reliability, and mobility. The 5G NR system is designed to provide flexibility and configurability to optimize network services and types, accommodating various use cases such as enhanced Mobile Broadband (eMBB), massive Machine-Type Communication (mMTC), and Ultra-Reliable and Low-Latency Communication (URLLC). As the demand for radio access continues to increase, however, there exists a need for further improvements in the art.

### SUMMARY

The present disclosure is related to a method and a user equipment for reporting UE capability for small data transmission (SDT) in next generation wireless communication networks.

In a first aspect of the present disclosure, a method performed by a user equipment (UE) for reporting UE capability for small data transmission (SDT) is provided. The method includes: receiving, from a base station (BS), a UE capability enquiry message; setting, in response to receiving the UE capability enquiry message, a content of a UE capability information message to indicate whether the UE supports random access (RA)-SDT; and transmitting, to the BS, the UE capability information message after setting the content of the UE capability information message.

In an implementation of the first aspect of the present disclosure, the RA-SDT is used for a transmission of data or signaling over allowed radio bearers via an RA procedure, while the UE is in a radio resource control (RRC) INACTIVE state.

In another implementation of the first aspect of the present disclosure, the method further includes setting the content of the UE capability information message to further indicate whether the UE supports configured grant (CG)-SDT.

In another implementation of the first aspect of the present disclosure, the CG-SDT is used for a transmission of data or signaling over allowed radio bearers via CG type 1, while the UE is in a radio resource control (RRC) INACTIVE state.

In another implementation of the first aspect of the present disclosure, the method further includes setting the content of the UE capability information message to further indicate whether the UE supports up to a maximum number of active CG configurations.

In another implementation of the first aspect of the present disclosure, the method further includes setting the content of the UE capability information message to further indicate the UE supports multiple CG-SDT configurations in a case that the UE supports the CG-SDT and the UE supports up to the maximum number of the active CG configurations.

In another implementation of the first aspect of the present disclosure, the method further includes submitting, by a radio resource control (RRC) layer of the UE, the UE capability information message to a lower layer of the UE for transmission.

In a second aspect of the present disclosure, a UE for reporting UE capability for small data transmission (SDT) is provided. The UE includes one or more non-transitory computer-readable media having computer-executable instructions embodied thereon; and at least one processor coupled to the one or more non-transitory computer-readable media. The at least one processor is configured to execute the computer-executable instructions to: receive, from a base station (BS), a UE capability enquiry message; set, in response to receiving the UE capability enquiry message, a content of a UE capability information message to indicate whether the UE supports random access (RA)-SDT; and transmit, to the BS, the UE capability information message after setting the content of the UE capability information message.

### BRIEF DESCRIPTION OF THE DRAWINGS

Aspects of the disclosure are best understood from the following detailed disclosure when read with the accompanying drawings. Various features are not drawn to scale. Dimensions of various features may be arbitrarily increased or reduced for clarity of discussion.

FIG. 1 is a flowchart diagram illustrating an SDT procedure, according to an example implementation of the present disclosure.

FIG. 2 is a diagram illustrating a Random Access (RA)-based SDT procedure, according to an example implementation of the present disclosure.

FIG. 3 is a diagram illustrating a Configured Grant (CG)-based SDT procedure, according to an example implementation of the present disclosure.

FIG. 4 is a schematic diagram illustrating a subsequent transmission period (or subsequent transmission phase) of an SDT procedure, according to an example implementation of the present disclosure.

FIG. 5 is a diagram illustrating a process of a UE capability transfer, according to an example implementation of the present disclosure.

FIG. 6 is a diagram illustrating a process of a UE assistance information transfer, according to an example implementation of the present disclosure.

FIG. 7 is a flowchart illustrating a method performed by a UE for reporting UE capability for small data transmission (SDT), according to an example implementation of the present disclosure.

FIG. 8 is a block diagram illustrating a node for wireless communication, according to an example implementation of the present disclosure.

### DESCRIPTION

Some of the acronyms used in the present application are defined as follows, unless otherwise specified:

| Acronym | Full name |
|---|---|
| 3GPP | 3^{rd} Generation Partnership Project |
| 5G | 5^{th} generation |
| 5GC | 5G Core |
| Alt | Alternative |
| ACK | Acknowledge |
| AS | Access Stratum |
| BS | Base Station |
| BSR | Buffer Status Report |
| BWP | Bandwidth Part |
| CBRA | Contention Based Random Access |
| CCCH | Common Control Channel |
| CE | Control Element |
| CFRA | Contention Free Random Access |
| CG | Configured Grant |
| CORESET | Control Resource Set |
| C-RNTI | Cell-Radio Network Temporary Identifier |
| CS | Cyclic Shift |
| CSI | Channel State Information |
| CS-RNTI | Configured Scheduling RNTI |
| CSS | Common Search Space |
| DCI | Downlink Control Information |
| DFI | Downlink Feedback Information |
| DG | Dynamic Grant |
| DL | Downlink |
| DMRS | Demodulation Reference Signal |
| DRB | Data Radio Bearer |
| DRX | Discontinuous Reception |
| FR | Frequency Range |
| HARQ | Hybrid Automatic Repeat reQuest |
| IE | Information Element |
| LCH | Logical Channel |
| LCP | Logical Channel Prioritization |
| MAC | Medium Access Control |
| MCG | Master Cell Group |
| MPE | Maximum Permissible Exposure |
| Msg | Message |
| NACK | Non-Acknowledge |
| NAS | Non-Access Stratum |
| NR | New Radio |
| NW | Network |
| NUL | Normal Uplink |
| PCell | Primacy Cell |
| PDCCH | Physical Downlink Control Channel |
| PDSCH | Physical Downlink Shared Channel |
| PDU | Protocol Data Unit |
| PHR | Power Headroom Reporting |
| PHY | Physical Layer |
| PRACH | Physical Random Access Channel |
| PRB | Physical Resource Block |
| PUCCH | Physical Uplink Control Channel |
| PUSCH | Physical Uplink Shared Channel |
| QCL | Quasi Co Location |
| RA | Random Access |
| RACH | Random Access Channel |
| RAR | Random Access Response |
| RB | Radio Bearer |
| Rel | Release |
| RLC | Radio Link Control |
| RNA | RAN notification area |
| RNTI | Radio Network Temporary Identifier |
| RO | RACH Occasion |
| RRC | Radio Resource Control |
| RS | Reference Signal |
| RSRP | Reference Signal Received Power |
| Rx | Reception |
| SCell | Secondary Cell |
| SCG | Secondary Cell Group |
| SCS | Subcarrier Spacing |
| SDT | Small Data Transmission |
| SDU | Service Data Unit |
| SI | System Information |
| SIB | System Information Block |
| SPS | Semi-Persistent Scheduling |
| SRB | Signaling Radio Bearer |
| SR | Scheduling Request |
| SRS | Sounding Reference Signal |
| SS | Search Space |
| SSB | SS/PBCH Block |
| SS-RSRP | Synchronization Signal-RSRP |
| SUL | Supplementary Uplink |
| TA | Timing Alignment or Time Advance |
| TAG | Timing Advance Group |
| TAT | Timing Alignment Timer |
| TCI | Transmission Configuration Indicator |
| TS | Technical Specification |
| Tx | Transmission |
| TBS | Transport Block Size |
| TRP | Transmission and Reception Point |
| UCI | Uplink Control Information |
| UE | User Equipment |
| UL | Uplink |
| USS | UE-specific Search Space |

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art. Unless noted otherwise, like or corresponding elements among the drawings may be indicated by like or corresponding reference numerals. Moreover, the drawings and illustrations in the present disclosure are generally not to scale and are not intended to correspond to actual relative dimensions.

For the purposes of consistency and ease of understanding, like features may be identified (although, in some examples, not illustrated) by the same numerals in the drawings. However, the features in different implementations may be different in other respects and shall not be narrowly confined to what is illustrated in the drawings.

The phrases “in one implementation,” or “in some implementations,” may each refer to one or more of the same or different implementations. The term “coupled” is defined as connected whether directly or indirectly via intervening components and is not necessarily limited to physical connections. The term “comprising” means “including, but not necessarily limited to” and specifically indicates open-ended inclusion or membership in the so-disclosed combination, group, series or equivalent. The expression “at least one of A, B and C” or “at least one of the following: A, B and C” means “only A, or only B, or only C, or any combination of A, B and C.”

For the purposes of explanation and non-limitation, specific details such as functional entities, techniques, protocols, and standards are set forth for providing an understanding of the disclosed technology. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof. A software implementation may include computer executable instructions stored on a computer readable medium such as memory or other type of storage devices. One or more microprocessors or general-purpose computers with communication processing capability may be programmed with corresponding executable instructions and perform the disclosed network function(s) or algorithm(s). The microprocessors or general-purpose computers may include Application-Specific Integrated Circuits (ASICs), programmable logic arrays, and/or using one or more Digital Signal Processor (DSPs). Although some of the disclosed implementations are oriented to software installed and executing on computer hardware, alternative implementations implemented as firmware or as hardware or as a combination of hardware and software are well within the scope of the present disclosure.

The computer-readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture, such as a Long-Term Evolution (LTE) system, an LTE-Advanced (LTE-A) system, an LTE-Advanced Pro system, or a 5G NR Radio Access Network (RAN), typically includes at least one base station (BS), at least one UE, and one or more optional network elements that provide connection within a network. The UE communicates with the network, such as a Core Network (CN), an Evolved Packet Core (EPC) network, an Evolved Universal Terrestrial RAN (E-UTRAN), a 5G Core (5GC), or an internet via a RAN established by one or more BSs.

A UE may include but is not limited to a mobile station, a mobile terminal or device, or a user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals over an air interface to one or more cells in a RAN.

ABS may be configured to provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

The BS may include but is not limited to a node B (NB) in the UMTS, an evolved node B (eNB) in LTE or LTE-A, a radio network controller (RNC) in UMTS, a BS controller (BSC) in the GSM/GERAN, an ng-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. The BS may serve one or more UEs via a radio interface.

The BS is operable to provide radio coverage to a specific geographical area using a plurality of cells forming the RAN. The BS supports the operations of the cells. Each cell is operable to provide services to at least one UE within its radio coverage. Each cell (often referred to as a serving cell) may provide services to one or more UEs within its radio coverage such that each cell schedules the DL and optionally UL resources to at least one UE within its radio coverage for DL and optionally UL packet transmissions. The BS can communicate with one or more UEs in the radio communication system via the plurality of cells. A cell may allocate sidelink (SL) resources for supporting Proximity Service (ProSe) or Vehicle to Everything (V2X) service. Each cell may have overlapped coverage areas with other cells.

As discussed above, the frame structure for NR supports flexible configurations for accommodating various next generation (e.g., 5G) communication requirements such as Enhanced Mobile Broadband (eMBB), Massive Machine Type Communication (mMTC), and Ultra-Reliable and Low-Latency Communication (URLLC), while fulfilling high reliability, high data rate, and low latency requirements. The Orthogonal Frequency-Division Multiplexing (OFDM) technology in the 3rd Generation Partnership Project (3GPP) may serve as a baseline for an NR waveform. The scalable OFDM numerology such as adaptive sub-carrier spacing, channel bandwidth, and Cyclic Prefix (CP) may also be used. Additionally, two coding schemes are considered for NR, specifically Low-Density Parity-Check (LDPC) code and Polar Code. The coding scheme adaption may be configured based on channel conditions and/or service applications.

Moreover, it is also considered that in a transmission time interval TX of a single NR frame, downlink (DL) transmission data, a guard period, and uplink (UL) transmission data should at least be included, where the respective portions of the DL transmission data, the guard period, and the UL transmission data should also be configurable, for example, based on the network dynamics of NR. In addition, sidelink resources may also be provided in an NR frame to support ProSe services.

In addition, the terms “system” and “network” herein may be used interchangeably. The term “and/or” herein is only an association relationship for describing associated objects and represents that these relationships may exist. For example, A and/or B may indicate that: A exists alone, A and B exist at the same time, or B exists alone. In addition, the character “/” herein generally represents that the former and latter associated objects are in an “or” relationship.

Examples of some selected terms used in this disclosure are provided, as follows.

User Equipment (UE): A UE may also be referred to as a PHY/MAC/RLC/PDCP/SDAP/RRC/AS/NAS layer/entity. The PHY/MAC/RLC/PDCP/SDAP/RRC/AS/NAS layer/entity may also be referred to as the UE.

Network (NW): An NW may include a network node, a TRP, a cell (e.g., SpCell, PCell, PSCell, and/or SCell), an eNB, a gNB, and/or a base station (BS).

Serving Cell: A serving cell may include a PCell, a PSCell, or an SCell. A serving cell may also include an activated or a deactivated serving cell.

Special Cell (SpCell): For a DC operation, an SpCell may be referred to as a PCell of an MCG or a PSCell of an SCG depending on whether the MAC entity (e.g., of the UE) is associated with the MCG or the SCG, otherwise, the SpCell may be referred to as the PCell.

Common/Dedicated configuration: A common configuration may be referred to as a cell-specific configuration, and a dedicated configuration may be referred to as a UE-specific configuration. The common parameters of an initial bandwidth part of a PCell may be provided via system information. For all other serving cells, the network may provide the common parameters via dedicated signaling.

The terms “RA-based SDT” and “RA-SDT” may be interchangeably used in some implementations of the present disclosure. The terms “CG-based SDT” and “CG-SDT” may be interchangeably used in some implementations of the present disclosure. The terms “initiate,” “trigger,” “apply,” “store,” “perform” and “start” may be interchangeably used in some implementations of the present disclosure. The terms “terminate,” “stop,” “release,” “suspend,” “discard,” “end,” “complete,” “abort,” and “cancel” may be interchangeably used in some implementations of the present disclosure. The terms “period,” “process,” “phase,” and “duration” may be interchangeably used in some implementations of the present disclosure. The terms “resource,” “occasion,” and “configuration” may be interchangeably used in some implementations of the present disclosure. The terms “ongoing,” “running,” and “pending” may be interchangeably used in some implementations of the present disclosure. The terms “beam,” “SSB,” and “CSI-RS” may be interchangeably used in some implementations of the present disclosure. The terms “select,” “consider” and “determine” may be interchangeably used in some implementations of the present disclosure.

Small Data Transmission (SDT)

In NR, until 3GPP release 16 (Rel-16), an RRC_INACTIVE state may not support data transmission (e.g., UL data transmission on a PUSCH and/or DL data transmission on a PDSCH). Hence, the UE may have to resume the connection (e.g., transition to the RRC_CONNECTED state) for any DL reception and/or UL data transmission. The connection setup and subsequently release to the RRC_INACTIVE state may happen for each data transmission regardless of how small and infrequent the data packets are. This may result in unnecessary power consumption and signaling overhead. The signaling overhead for the RRC_INACTIVE state UEs due to transmission of small data packets may be a general problem and may become a critical issue as the number of UEs increases in NR, not only for network performance and efficiency, but also for the UE's battery performance. In general, any device that has intermittent transmission of small data packets in the RRC_INACTIVE state may benefit from enabling small data transmission in the RRC_INACTIVE state. The key enablers for small data transmission in NR, namely the RRC_INACTIVE state, 2-step RACH, 4-step RACH, and/or configured grant type-1 have already been specified as part of legacy.

A Small Data Transmission (SDT) may be a procedure that allows data transmission while the UE is remaining in the RRC_INACTIVE state (e.g., without transitioning to the RRC_CONNECTED state). The SDT may be enabled on a radio bearer (RB) basis and may be initiated by the UE only if (i) less than a configured amount of UL data awaits transmission across all radio bearers (e.g., SRBs and/or DRBs) for which SDT is enabled, (ii) measured RSRP in the cell is above a configured threshold, and (iii) a valid resource for SDT is available.

An SDT procedure may be configured to either take place on the RACH (e.g., RA-based SDT, and configured via system information) or via type 1 CG resources (e.g., CG-based SDT, and configured via dedicated signaling in RRC Release message). The SDT resources may be configured on the initial BWP or for CG, additionally, on a dedicated BWP. For RACH, the network may also configure whether the 2-step or 4-step RA types can be used. When both the 2-step and 4-step RA types can be used, the UE may select the RA type. When only the 2-step RA can be used, the SDT may only be initiated if the criteria to select a 2-step RA type is also met.

Once the SDT is initiated, an SDT procedure may last as long as the UE is not explicitly directed to an RRC_IDLE state or an RRC_INACTIVE state (e.g., via an RRC Release message) or to an RRC_CONNECTED state (e.g., via an RRC Resume message). Additionally, once the SDT is initiated, an SDT procedure may last until (i) cell re-selection, (ii) expiry of the SDT failure detection timer, or (iii) an RLC entity reaching a configured maximum retransmission threshold, otherwise, the UE may transition to the RRC_IDLE state.

After initialing the SDT transmission, subsequent transmissions may be handled differently depending on the type of resources configured. When the CG resources are used, the network may schedule a subsequent UL transmission using dynamic grants or the subsequent UL transmission may take place on the next CG resource occasions. The DL transmissions may be scheduled using dynamic assignments. When the RACH resources are used, the network may schedule subsequent UL and DL transmissions using dynamic grants and/or assignments, respectively, after the completion of the RA procedure.

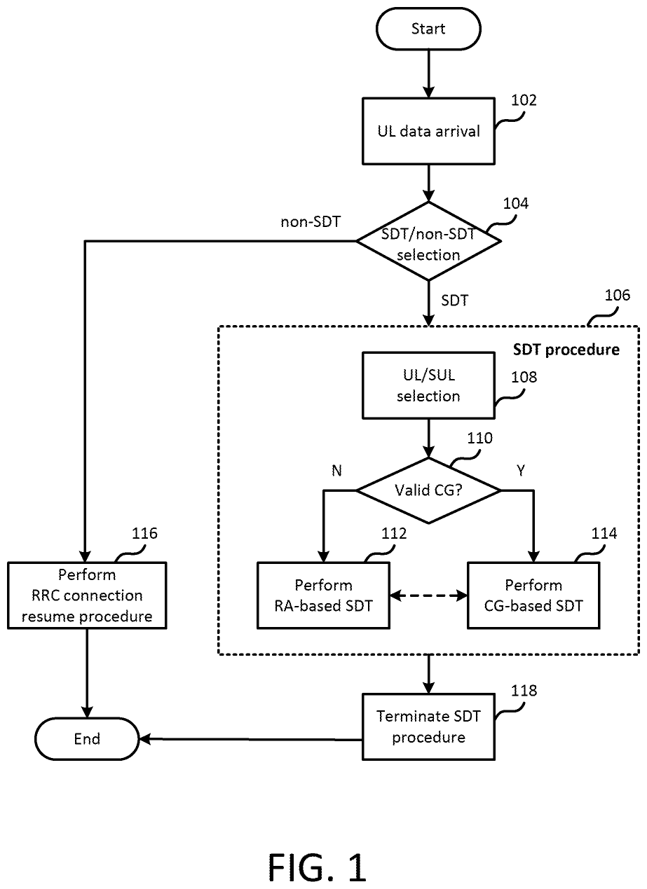

FIG. 1 is a flowchart diagram illustrating an SDT procedure, according to an example implementation of the present disclosure. In some implementations, the illustrated SDT procedure may be performed by the UE.

The UE may be in an RRC_INACTIVE state when the illustrated SDT procedure is initiated. Additionally, the UE may be configured with SDT configurations (e.g., via an information element (IE), such as the IE sdt-Config and/or the IE sdt-ConfigCommon). The SDT configurations may be configured via an RRC release message (and/or via a suspend configuration message), and/or via system information (e.g., SIB). The configuration(s) for SDT may include a RACH configuration (e.g., configured via the IE ra-SDT-config), a CG configuration (e.g., configured via the IE cg-SDT-config), configuration(s) for SRB/DRB used for SDT, DRB list (e.g., configured via the IE sdt-DRBList), and/or an SRB indication (e.g., configured via the IE SRB2Indication).

In action 102, UL data may be arrived at the UE for transmission. The received UL data may be associated with a specific DRB/SRB/LCH. The specific DRB/SRB/LCH may be configured for SDT. The specific DRB/SRB/LCH may be configured by a DRB list (e.g., via the IE sdt-DRBList) and/or an SRB indication (e.g., via the IE SRB2Indication). Then the UE may initiate (or resume) a procedure for SDT (e.g., an SDT procedure).

The UE (e.g., a MAC entity of the UE) may be configured (e.g., via RRC signaling or through a SIB) with the SDT configuration, and an SDT procedure may be initiated (e.g., by the RRC layer and/or the MAC layer) by the UE. The SDT may be performed either via an RA procedure with the 2-step RA type or the 4-step RA type (e.g., RA-SDT) or via a configured grant type 1 (e.g., CG-SDT). For the SDT procedure, the UE (e.g., the MAC entity of the UE) may consider the radio bearers configured with SDT which are suspended for data volume calculation.

In action 104, the UE may determine whether to start an SDT procedure 106 (e.g., initiate the SDT procedure, initiate an RA procedure for SDT, and/or initiate an SDT procedure with CG), or initiate a non-SDT procedure (e.g., an RRC connection resume procedure) 116, (e.g., by initiating an RA procedure for a CCCH logical channel). The UE may determine whether to initiate an SDT procedure 106 or initiate a non-SDT procedure 116 based on one or more criteria (e.g., DRB/SRB, data volume, and/or RSRP).

In some implementations, the UE may initiate the SDT procedure when/after at least one LCH/DRB/SRB is configured for SDT, and the at least one LCH/DRB/SRB has pending data. For example, the data may be available for transmission for LCHs/DRBs/SRBs for which the SDT is enabled. The LCH/DRB/SRB configured for SDT may be resumed/re-established when the UE initiates the SDT procedure. The UE may initiate the RRC connection resume procedure when/after at least one LCH/DRB/SRB is not configured for SDT, and the at least one LCH/DRB/SRB has pending data. In some implementations, the UE may initiate the SDT procedure if data volume for transmission (e.g., for SDT) is lower than a (configured) threshold for SDT. The data volume may count the (total) volume of the LCHs/DRBs/SRBs configured for SDT. The UE may initiate an RRC connection resume procedure if the data volume for transmission (e.g., for SDT) is higher than a (configured) threshold for SDT. In some implementations, the UE may initiate the SDT procedure if an RSRP is larger than a configured RSRP threshold for SDT. The UE may initiate an RRC connection resume procedure if an RSRP is lower than a configured RSRP threshold for SDT.

In action 106, there may be two types of the SDT procedure. One type may be based on the RA procedure (e.g., 2-step RA or 4-step RA). The SDT based on the RA procedure may be referred to as the RA-based SDT 112 (or may also be referred to as the RA-SDT). The other type may be based on the CG (e.g., type 1 CG). The SDT based on the CG may also be referred to as the CG-based SDT 114 (or may also be referred to as the CG-SDT). The UE may transmit the UL data (e.g., small data), via an Msg3, an MsgA, a CG resource, and/or one or more PUSCH resources, during the SDT procedure.

In action 108, the UE may perform UL carrier selection (e.g., if SUL is configured in the cell, the UL carrier may be selected based on the RSRP threshold). After the UL carrier selection, the UE may perform the SDT procedure on the selected UL carrier (e.g., either UL or SUL).

Table 1 below shows an example of an SDT procedure.

TABLE 1
The UE/MAC entity may:

| 1> | if the data volume of the pending UL data accorss all logical channels configured for Small | |
|---|---|---|
| | Data Transmission is less or equal than sdt-DataVolumeThreshold: | |
| 2> | if the Serving Cell for Small Data Transmission is configured with supplementary uplink as | |
| | specified in the 3GPP TS 38.331; and | |
| 2> | if the RSRP of the downlink pathloss reference is less than sdt-RSRP-ThresholdSSB-SUL: | |
| | 3> | select the SUL carrier. |
| 2> | else: | |
| | 3> | select the NUL carrier. |
| 2> | if the RSRP of the downlink pathloss reference is higher than sdt-RSRP-Threshold, if | |
| | configured: | |
| | 3> | if configured grant type 1 is configured for Small Data Transmission, and the configured |

| grant type 1 resource is valid: | |
|---|---|
| 4> | initiate Small Data Transmission with configured grant type 1 on the selected UL |
| | carrier; |
| 4> | indicate to the upper layer that conditions for initiating Small Data Transmission are |

fulfilled.

| | |
|---|---|
| 3> | else if Random Access Resources are configured for Small Data Transmission: |

| 4> | initiate Random Access procedure on the selected UL carrier for Small Data |
|---|---|
| | Transmission; |
| 4> | indicate to the upper layer that conditions for initiating Small Data Transmission are |

fulfilled.

| | |
|---|---|
| 3> | else: |

| | |
|---|---|
| 4> | initiate Random Access procedure for CCCH logical channel (e.g., not for Small Data |

Transmission);

| | |
|---|---|
| 2> | else: |

3>initiate Random Access procedure for CCCH logical channel (e.g., not for Small Data

Transmission);

| | |
|---|---|
| 1> | else: |
| 2> | initiate Random Access procedure for CCCH logical channel (e.g., not for Small Data |
| | Transmission); |

In action 110, the UE may determine whether a CG resource/configuration is valid (during the SDT procedure) based on one or more of the following criteria.

The UE may determine whether a CG resource/configuration is valid based on whether an associated beam is valid. Determining whether the associated beam is valid or not may be based on an RSRP threshold. The RSRP threshold may be configured in the RRC release message and/or the CG configuration. If there is at least one beam with RSRP above the RSRP threshold, the UE may determine that the CG resource/configuration is valid. If there is no beam with RSRP above the RSRP threshold, the UE may determine that the CG resource/configuration is not valid.

The UE may also determine whether a CG resource/configuration is valid based on whether the TA is valid. For example, the UE may determine that the CG resource/configuration is valid during the time that the TA is valid. If the TA is not valid (e.g., expired), the UE may determine that the CG resource/configuration is not valid. Whether a TA is valid may be based on a TA timer. For example, the UE may determine that the TA is valid while the TA timer is running. The UE may determine that the TA is not valid when the TA timer is not running. The (parameter of) TA timer may be configured in the RRC release message and/or the CG configuration. Whether a TA is valid may also be based on an RSRP change volume. For example, the UE may determine that the TA is not valid if the RSRP change volume is higher than a threshold. The threshold (for RSRP change volume) may be configured in the RRC release message and/or the CG configuration.

Table 2 below shows an example of validation for SDT using CG.

TABLE 2
The UE may consider the time alignment value for Small Data
Transmission using configured grant type 1 to be valid when the following
conditions are fulfilled:

| | |
|---|---|
| 1> | compared to the stored downlink pathloss reference RSRP value, |
| | the RSRP has not increased by more than |
| | cg-SDT-RSRP-ChangeThresholdIncrease, if configured; and |
| 1> | compared to the stored downlink pathloss reference RSRP value, |
| | the RSRP has not decrease by more than |
| | cg-SDT-RSRP-ChangeThresholdDecrease, if configured |

The UE may determine whether a CG resource is valid based on whether the CG configuration is valid. In some implementations, when the CG resource configuration is (re)initialized, the CG resource configuration may be determined as being valid, otherwise the CG resource configuration may be determined as being invalid. The CG resource configuration may be configured in the RRC release message.

The UE may also determine whether a CG resource/configuration is valid based on whether a timer (e.g., an SDT failure detection timer) is running or not. In some implementations, the timer may be configured in the RRC release message and/or the CG configuration. The UE may determine that the CG resource/configuration is valid while the timer is running, otherwise the CG resource/configuration is not valid. Such a timer may be used, in some implementations, to detect the failure of the SDT. The timer may be (re)started upon transmission of UL data when the UE is in the RRC_INACTIVE state. The timer may also be (re)started upon transmission of small data, or upon transmission of an RRC resume request. Additionally, the timer may be stopped upon reception of an RRCResume, RRC Setup, RRCRelease, or an RRCRelease with suspendConfig, or an RRCReject message. The timer may also be stopped during a cell re-selection or upon abortion of a connection establishment by the upper layers. When the timer expires, the UE may perform the actions upon going to the RRC_IDLE state (e.g., with a specific RRC resume cause).

Returning to FIG. 1, if the UE determines, in action 110, that the CG resource/configuration is not valid (e.g., one of the criteria for CG validity is not satisfied), the UE may perform, in action 112, an RA-based SDT procedure. For example, the UE may initiate an RA procedure (e.g., for SDT). The RA procedure may be either a 2-step or a 4-step type based on what the UE selects (e.g., according to an RSRP threshold). The UE may perform the transmission of the RA preamble (e.g., via the preamble/RA resource/PRACH resource which is configured for the SDT). The UE may perform the UL transmission (e.g., small data) via an Msg3/MsgA.

On the other hand, if the UE determines, in action 110, that the CG is valid (e.g., one or more criteria for the CG validity are satisfied), the UE may perform, in action 114, a CG-based SDT procedure. For example, the UE may perform the UL transmission (e.g., for small data) via a CG resource.

Additionally, if the criteria (e.g., DRB/SRB, data volume, and/or RSRP), in action 104, for initiating the SDT procedure is not satisfied, the UE may initiate, in action 116, a non-SDT procedure (e.g., RRC connection resume procedure). For example, the UE may initiate an RA procedure for a CCCH logical channel.

In action 118, the SDT procedure may be terminated/stopped/completed, for example, after receiving an indication from the NW (e.g., via RRC release message), or via a timer (e.g., an SDT failure detection timer expires), and/or by a counter (e.g., the value of the counter reaches a maximum value).

In some implementations, the SDT procedure may fallback/switch to the non-SDT procedure (e.g., an RRC connection resume procedure). For example, when the UE receives an indication (e.g., a fallback indication via an RRC resume/RRC release message) from the NW, the UE may stop/terminate/complete the SDT procedure and then may initiate an RRC connection resume procedure. If the initial UL transmission (e.g., in MsgA/Msg3/CG resources) fails a (configured) number of times, the UE may stop/terminate/complete the SDT procedure and then may initiate an RRC connection resume procedure. While an RA procedure of an RA-based SDT is ongoing and the condition to fallback/switch to the non-SDT procedure (e.g., RRC connection resume procedure) is satisfied, the UE may switch the RA type of the RA procedure from a 4-stepRA-SDT/2-stepRA-SDT type to a 4-stepRA/2-stepRA type.

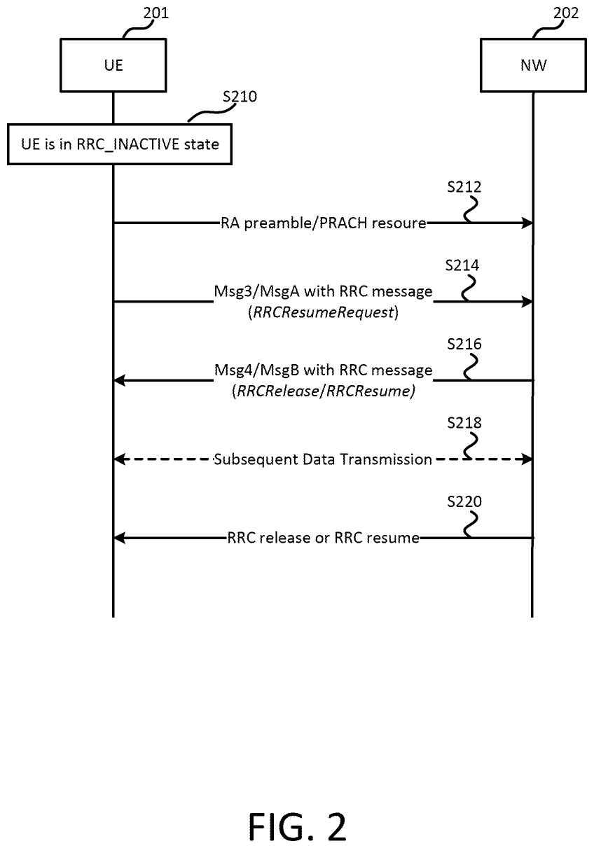

FIG. 2 is a diagram illustrating an RA-based SDT procedure, according to an example implementation of the present disclosure.

FIG. 2, as shown illustrate communications between the UE 201 and the NW 202. In action S210, the UE 201 may be in an RRC_INACTIVE state.

Next, in action S212, when the UE 201, in the RRC_INACTIVE state, has UL data available for transmission and/or an SDT procedure has been initiated, the UE 201 may initiate an RA-based SDT procedure for the transmission of the UL data (e.g., in a case that the CG is considered as not valid). The UE 201 may select either the 4-step RA type or the 2-step RA type. The preamble/PRACH resource for the RA-based SDT procedure (e.g., RA preamble/PRACH resource configured for SDT) and the normal RA procedure (e.g., RA preamble not configured for SDT) may be different. Here, the UE 201 may select the preamble/PRACH resource configured for SDT.

In action S214, after transmitting the RA preamble, the UE 201 may transmit an RRC message (e.g., a CCCH message), MAC CE(s), and/or UL data through an Msg3 (e.g., when the 4-step RA type is selected) or an MsgA (e.g., when the 2-step RA type is selected). The RRC message may be an RRCResumeRequest message. In addition to the RRC message, MAC CE (e.g., BSR), and UL data (e.g., data associated with DRB(s) for SDT) may be included in the Msg3/MsgA as well.

In action S216, once the Msg3/MsgA is transmitted, the UE 201 may monitor Temporary C-RNTI/C-RNTI/RA-RNTI/MSGB-RNTI for Msg4/MsgB, in which the contention resolution ID may be carried. In addition, the NW 202 may transmit an RRC message in an Msg4/MsgB. The RRC message may be an RRC Release message (e.g., with suspendConfig IE) or an RRC Resume message. The UE 201 may stay in the RRC_INACTIVE state if the UE 201 receives an RRC Release message (e.g., with suspendConfig IE) or transitions to the RRC_CONNECTED state, for example, if the UE 201 receives an RRC Resume message.

In action S218, once the RA procedure for SDT is successfully completed, the UE 201 may monitor a specific RNTI (e.g., C-RNTI) on a specific search space for subsequent data transmission. The subsequent data transmission may be the transmission of multiple UL and/or DL data packets as part of the SDT procedure without transitioning to the RRC_CONNECTED state (e.g., while the UE 201 may still be in the RRC_INACTIVE state). The UE 201 may monitor a PDCCH via a specific RNTI (e.g., C-RNTI) to receive the dynamic scheduling for the UL and/or DL new transmissions and/or the corresponding UL and/or DL retransmissions. The UE 201 may monitor a PDCCH via a UE specific RNTI (e.g., C-RNTI) to receive the dynamic scheduling for the retransmission of the UL data via a CG resource.

In action S220, the NW 202 may send an RRC release message (e.g., with suspendconfig) to keep the UE 201 in the RRC_INACTIVE state, or to move the UE to the RRC_IDLE state. The NW 202 may send an RRC resume message to move the UE 201 to the RRC_CONNECTED state. Once the RRC Release message (e.g., with suspendConfig IE) is received, the UE 201 may terminate the SDT procedure based on the RRC Release message, and/or may stop monitoring the C-RNTI, and/or may stay in the RRC_INACTIVE state.

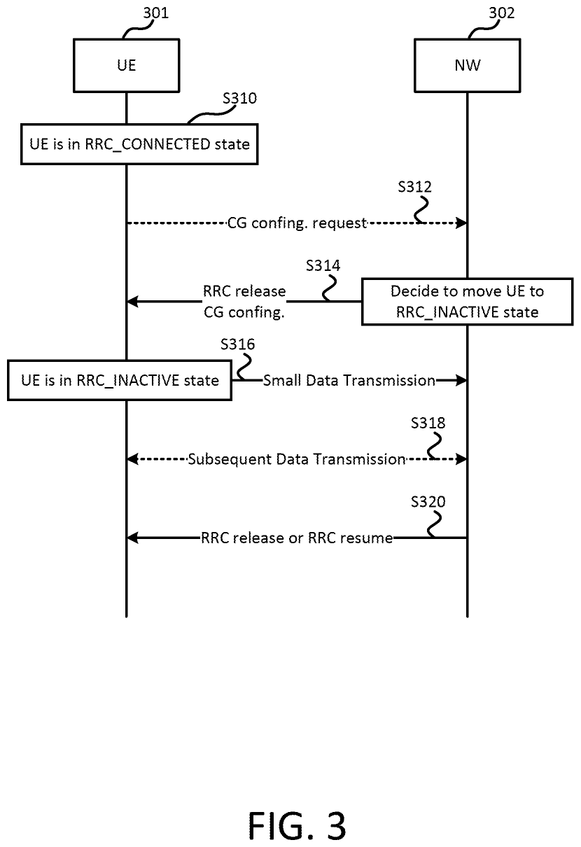

FIG. 3 is a diagram illustrating a CG-based SDT procedure, according to an example implementation of the present disclosure.

FIG. 3, as shown illustrate communications between the UE 301 and the NW 302. In action S310, the UE 301 may be in an RRC_CONNECTED state.

Next, in action S312, when the UE 301 is in the RRC_CONNECTED state, the UE 301 may send a CG configuration request to the NW 302 to indicate its preference on CG configuration for small data and/or for the RRC_INACTIVE state.

In action S314, the NW 302 may decide to move the UE 301 to the RRC_INACTIVE state by sending an RRC Release message (e.g., including suspendconfig IE) to the UE 301. The RRC release message may include at least one CG configuration to configure the CG resources to the UE 301. The CG configuration may include, but is not limited to, a CG periodicity, a TBS, a number for the implicit release of the CG resources, a CG Timer, a retransmission timer, a number of HARQ processes reserved for the CG in SDT, an RSRP threshold for SSB selection and association between the SSB and CG resources, and TA related parameters (e.g., cg-SDT-TimeAlignmentTimer).

In action S316, the UE 301 may perform the SDT procedure based on the CG resources (e.g., in the RRC_INACTIVE state) according to the CG configuration (e.g., configured in S314). For example, the UE 301 may transmit UL data (e.g., small data) via the CG resource (e.g., during the SDT procedure).

In action S318, subsequent data transmission may be a transmission of multiple UL and/or DL packets, as part of the SDT procedure without transitioning to the RRC_CONNECTED state (e.g., the UE 301 may still be in the RRC_INACTIVE state). The UE 301 may monitor a PDCCH via a specific RNTI (e.g., C-RNTI, CS-RNTI, and/or an SDT RNTI) on a search space (e.g., configured by a CG configuration) to receive dynamic scheduling for new UL and/or DL transmissions and/or the corresponding UL and/or DL retransmission. The UE 301 may monitor a PDCCH via the specific RNTI to receive the dynamic scheduling for the retransmission of the CG. The UE 301 may also perform a subsequent data transmission via a CG resource according to the CG configuration (e.g., configured in S314).

In action S320, the NW 302 may send an RRC release (with suspendconfig) message to keep the UE 301 in the RRC_INACTIVE state or to move the UE 301 to the RRC_IDLE state. The NW 302 may send an RRC resume message to move the UE 301 to the RRC_CONNECTED state. Once the RRC Release message (e.g., with suspendConfig IE) is received, the UE 301 may terminate the SDT procedure based on the RRC Release message, and/or may stop monitoring the specific RNTI, and/or may stay in the RRC_INACTIVE state.

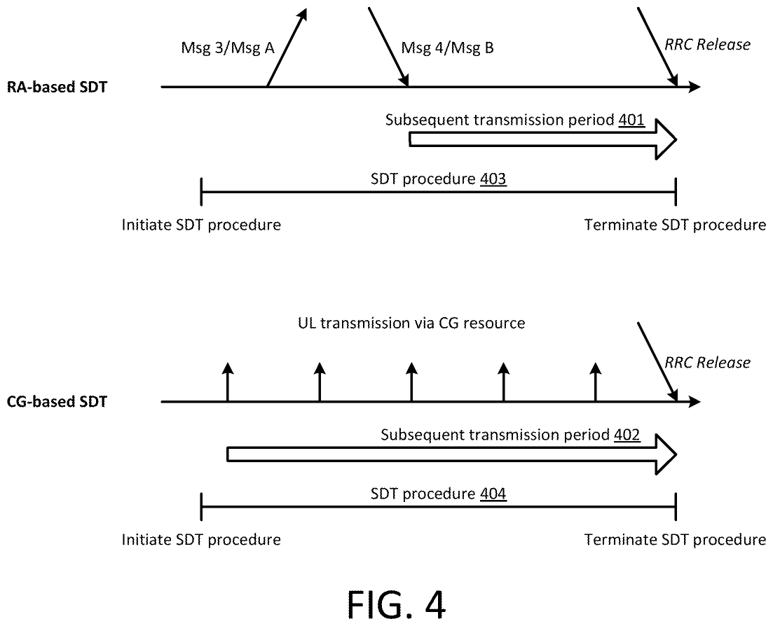

FIG. 4 is a schematic diagram illustrating a subsequent transmission period (or subsequent transmission phase) of an SDT procedure, according to an example implementation of the present disclosure.

The subsequent transmission period 401 may be determined as a time period during an RA-based SDT procedure 403. The subsequent transmission period 402 may be determined as a time period during a CG-based SDT procedure 404. For example, the subsequent transmission periods 401, 402 may be time periods during which the SDT procedures 403, 404, respectively, are ongoing. For example, the subsequent transmission period 402 may be a time period while a CG configuration is configured, or after the CG configuration is initiated (e.g., and the CG configuration is not released).

In some implementations, the subsequent transmission period 401 may be determined as started when/after the UE initiates the SDT procedure 403. The subsequent transmission period 402 may be determined as started when/after the UE initiates the SDT procedure 404.

In some implementations, the subsequent transmission period 401 may be determined as started when/after the UE considers a contention resolution is successful for an RA procedure and/or after the UE considers the RA procedure as being successfully completed. The RA procedure may be an RA-based SDT. The RA procedure may be initiated for the SDT.

In some implementations, the subsequent transmission period 402 may be determined as started when/after the CG configuration is configured/(re)initialized. The CG configuration may include a parameter which may be used to indicate the SDT scheduling.

In some implementations, the subsequent transmission period 402 may be determined as started when/after the CG configuration is considered as valid.

In some implementations, the subsequent transmission periods 401, 402 may be determined as started when/after the UE transmits a UL message. The UL message may be transmitted via an Msg1/Msg3/MsgA/CG resource/UL resource scheduled by Msg2/MsgB/Msg4 (e.g., during the SDT procedures 403, 404) or on an UL resource that is (pre)configured as part of the SDT configuration. The UL message may include an RRC resume request message (e.g., RRCResumeRequest, RRCResumeRequest1, and/or a CCCH message for SDT). The UL message may include small data (e.g., UL data associated with a specific SRB/DRB/LCH for SDT). The UL message may include a MAC CE (e.g., a BSR MAC CE).

In some implementations, the subsequent transmission periods 401, 402 may be determined as started when/after the UE receives a response from the NW. The response may be an Msg2/Msg4/MsgB and/or a response for a UL transmission via a CG resource. The response may be used for contention resolution (e.g., for an RA procedure). The response may include an (HARQ/RRC) ACK/NACK message, and/or a DFI, for example, for (the first) UL transmission via the CG resource. The response may contain a UL grant/DL assignment for a new transmission/retransmission. The response may be a PDCCH addressed to an RNTI (e.g., a C-RNTI, a CS-RNTI, a dedicated RNTI, an RNTI for SDT, and/or an RNTI for CG). The response may indicate a UL grant for a new transmission for the HARQ process used for the transmission of an UL transmission for small data (e.g., a UL message). The response may include a specific command (e.g., a TA command MAC CE). The response may include an RRCResume, RRCSetup, RRCRelease, RRCRelease with SuspendConfig, RRCReestablishment, RRCReconfiguration, and/or an RRCReject.

In some implementations, the subsequent transmission period 401 (and/or the SDT procedure 403) may be terminated/stopped when/after the SDT procedure 403 is terminated. The subsequent transmission period 402 (and/or the SDT procedure 404) may be terminated/stopped when/after the SDT procedure 404 is terminated.

In some implementations, the subsequent transmission period 402 (and/or the SDT procedure 404) may be terminated/stopped when/after the CG configuration is released/suspended/cleared.

In some implementations, the subsequent transmission period 402 (and/or the SDT procedure 404) may be terminated/stopped when/after the CG configuration is considered as invalid.

In some implementations, the subsequent transmission periods 401, 402 (and/or the SDT procedures 403, 404) may be terminated/stopped when/after the UE receives an indication from the NW. The indication may include an RRCResume, an RRCSetup, an RRCRelease, an RRCRelease with SuspendConfig, RRCReestablishment, and/or an RRCReject. The indication may be a PDCCH addressed to an RNTI (e.g., a C-RNTI, a CS-RNTI, a dedicated RNTI, an RNTI for SDT, and/or an RNTI for CG). The indication may indicate to the UE to terminate the SDT procedures 403, 404 and/or the subsequent transmission periods 401, 402 (e.g., via a field included in the indication). The indication may indicate to the UE to initiate an RRC procedure (e.g., an RRC connection resume procedure, an RRC establishment procedure, and/or an RRC reestablishment procedure). The indication may indicate to the UE to switch/fallback the types for SDT (e.g., the types may be an RA-based SDT, a CG-based SDT, a 2-step RA, or a 4-step RA). The indication (with a specific value, e.g., TRUE or FALSE) may be included in system information (e.g., a SIB) to indicate that the CG transmission in the RRC_INACTIVE state is no longer supported in the cell. For example, when the UE receives the indication (with a specific value, e.g., TRUE or FALSE), the UE may release/suspend the CG configuration(s).

In some implementations, the subsequent transmission periods 401, 402 (and/or the SDT procedures 403, 404) may be terminated/stopped when/after a timer expires. The timer may be an SDT failure/problem detection timer. The timer may be specifically configured for the SDT. The value of the timer may be configured via an RRC release message. The value of the timer may be configured via the RRC release message with suspend configuration. The value of the timer may be configured via a configuration for SDT. The value of the timer may be configured via a RACH configuration for SDT. The value of the timer may be configured via a CG configuration for SDT. The value of the timer may be configured via the IE UE-TimersAndConstants. The value of the timer may be configured via system information (e.g., a SIB). The timer may be a TA timer, ra-ResponseWindow, msgB-ResponseWindow, ra-ContentionResolutionTimer, configuredGrantTimer, cg-RetransmissionTimer, drx-onDurationTimer, drx-InactivityTimer, drx-Retransmi ssionTimerDL, drx-RetransmissionTimerUL, T300, T301, T302, T304, T310, T311, T312, T316, T319, T320, T321, T322, T325, T330, T331, T342, T345, and/or a new wait timer. The timer may be used for monitoring a response (e.g., for ACK/NACK). The timer may be a response window. The timer may be used for receiving a PDCCH/scheduling (e.g., for new transmission or retransmission) from the NW.

In some implementations, the subsequent transmission periods 401, 402 may be terminated/stopped when/after the UE enters an RRC_IDLE state or an RRC_CONNECTED state (e.g., from the RRC_INACTIVE state). In some implementations, the subsequent transmission periods 401, 402 may be terminated/stopped/released when/after the UE performs a cell selection/reselection. In some implementations, the subsequent transmission periods 401, 402 may be terminated/stopped upon the abortion of a connection establishment, for example, by the upper layers. In some implementations, the subsequent transmission periods 401, 402 may be terminated/stopped upon a RAN notification area (RNA) update. In some implementations, the subsequent transmission periods 401, 402 may be terminated/stopped when/after the UE establishes/resumes an RRC connection from the RRC_INACTIVE state on a cell different from the cell where the CG configuration was provided. In some implementations, the subsequent transmission periods 401, 402 may be terminated/stopped when/after the UE initiates an RRC re-establishment procedure. For example, the subsequent transmission periods 401, 402 may be terminated/stopped after the UE sends an RRCReestablishmentRequest to the network. In some implementations, the subsequent transmission periods 401, 402 may be terminated/stopped when/after the UE is indicated, by the network, to perform a carrier switching (e.g., from NUL to SUL or vice versa). In some implementations, the subsequent transmission periods 401, 402 may be terminated/stopped when/after the UE is indicated, by the network, to perform a (UL/DL) BWP switching.

In the subsequent transmission periods 401, 402, the UE may need to monitor the PDCCH (e.g., to receive the possible (DL and/or UL) scheduling from the NW). The UE may monitor the PDCCH (e.g., during the SDT procedures 403, 404 and/or during the subsequent transmission periods 401, 402) based on a search space, a CORESET, and/or an RNTI. For example, the UE may monitor the PDCCH addressed to the C-RNTI after a successful completion of the RA procedure for SDT.

The Search Space (SS) may be at least one of the following (a) and (b).

(a): Common Search Space (CSS) set: In some implementations, the CSS set may be the common search space(s) configured in the PDCCH-ConfigCommon, the type-1 PDCCH CSS set configured by ra-SearchSpace, the type-3 PDCCH CSS set, the search space zero, a new CSS set configured via system information (e.g., a SIB) or an RRC release message, and/or a search space with parameters of the search space(s) configured in the initial BWP.

(b): UE-specific Search Space (USS) set: In some implementations, the USS set may be a USS set configured via an RRC Release message, a USS configured via an Msg4/MsgB, a USS set configured via a PDCCH-Config, a USS set configured via a configuration(s) for SDT, a search space with an ID other than 0-39, and/or a search space set identified as specific set for SDT.

The CORESET may be at least one of the following (a) and (b).

(a): common CORESET: In some implementations, the common CORESET may be CORESET 0, or a CORESET other than CORESET 0.

(b): UE-specific CORESET configuration: In some implementations, the UE-specific CORESET configuration may be a UE-specific CORESET configured via an RRC Release message, a UE-specific CORESET configured via an Msg4/MsgB, a UE-specific CORESET configured via a configuration(s) for SDT, a CORESET with an ID other than 0-14.

The RNTI may include a C-RNTI, a CS-RNTI, an SDT-RNTI, an RNTI for SDT, an RNTI for CG.

RA Preambles Group Selection

For an RA procedure with the 4-step RA type, a UE may be configured with an RA preamble group B (e.g., via the IE GroupBconfigured).

In some implementations, if the UE is configured with the RA preamble group B, the UE may select the RA preambles group B in the RA procedure with the 4-step RA type when one or more of the following conditions (a)-(f) are satisfied. Otherwise, the UE may select group A.

(a): The potential Msg3 size (e.g., UL data available for transmission plus MAC subheader(s) and, where required, MAC CEs) is greater than an RA-Msg3-size-groupA threshold (e.g., based on the IE ra-Msg3 SizeGroupA).

(b): The pathloss is less than a value derived by the parameters configured in the RA configuration. The value may be derived by PCMAX (e.g., of the serving cell performing the Random Access Procedure)−preambleReceivedTargetPower−msg3-DeltaPreamble−messagePowerOffsetGroupB.

(c): The RA procedure was initiated for the CCCH logical channel. In some implementations, the RA procedure initiated for the SDT (e.g., RA-SDT procedure) may be determined by the UE as not being initiated for the CCCH logical channel (e.g., even if the UE transmits data from the CCCH logical channel via an Msg3/MsgA).

(d): The CCCH SDU size plus MAC subheader is greater than an RA-Msg3-size-groupA (e.g., based on the IE ra-Msg3SizeGroupA).

(e): The Msg3 buffer is empty.

(f): The Msg3 is being retransmitted.

In some implementations, the UE may select the RA preambles group B in the RA procedure with the 4-step RA type if the UE determines that (a) the Msg3 buffer is empty, (b) the potential Msg3 size (e.g., UL data available for transmission plus MAC subheader(s) and, where required, MAC CEs) is greater than an RA-Msg3-size-groupA threshold (e.g., based on the IE ra-Msg3 SizeGroupA), and/or (c) the pathloss is less than a value derived by the parameters configured in the RA configuration. The value may be derived by PCMAX (e.g., of the serving cell performing the Random Access Procedure)−preambleReceivedTargetPower−msg3-DeltaPreamble−messagePowerOffsetGroupB.

In some implementations, the UE may select RA preambles group B in the RA procedure with the 4-step RA type if the UE determines that (a) the RA procedure was initiated for the CCCH logical channel, and/or (b) the CCCH SDU size plus MAC subheader is greater than an RA-Msg3-size-groupA (e.g., based on the IE ra-Msg3 SizeGroupA).

In some implementations, the UE may select the same group of RA Preambles as was used for the RA Preamble transmission attempt corresponding to the first transmission of Msg3 in the RA procedure with the 4-step RA type when the Msg3 is being retransmitted. In some implementations, the UE may select the same group of RA Preambles as was used for the RA Preamble transmission attempt corresponding to the first transmission of Msg3 if the UE determines that the Msg3 is being retransmitted.

For an RA procedure with the 2-step RA type, a UE may be configured with the RA preamble group B (e.g., via the IE GroupB-ConfiguredTwoStepRA).

In some implementations, if the UE is configured with the RA preamble group B for the 2-step RA type, the UE may select the RA preambles group B in the RA procedure with the 2-step RA type when one or more of the following conditions (a)-(g) are satisfied. Otherwise, the UE may select group A.

(a): The potential MSGA payload size (e.g., UL data available for transmission plus MAC subheader(s) and, where required, MAC CEs) is greater than (or is equal to) an RA-MsgA-size-groupA threshold (e.g., based on the IE ra-MsgA-SizeGroupA).

(b): The pathloss is less than a value derived by the parameters configured in the RA configuration for the 2-step RA. The value may be derived by PCMAX (e.g., of the serving cell performing the Random Access Procedure)−preambleReceivedTargetPower−msg3-DeltaPreamble−messagePowerOffsetGroupB.

(c): The RA procedure was initiated for the CCCH logical channel. In some implementations, the RA procedure initiated for the SDT (e.g., an RA-SDT procedure) may be determined by the UE as not being initiated for the CCCH logical channel (e.g., even if the UE transmits data from the CCCH logical channel via an Msg3/MsgA).

(d): The CCCH SDU size plus MAC subheader is greater than (or is equal to) an RA-MsgA-size-groupA (e.g., based on the IE ra-MsgA-SizeGroupA).

(e): The RA Preambles group has not yet been selected.

(f): The RA Preambles group has been selected.

(g): The contention-free RA Resources for the 2-step RA type have not been configured.

In some implementations, the UE may select the RA preambles group B in the RA procedure with the 2-step RA type if the UE determines that (a) the potential MSGA payload size (e.g., UL data available for transmission plus MAC subheader(s) and, where required, MAC CEs) is greater than an RA-MsgA-size-groupA threshold (e.g., based on the IE ra-MsgA-SizeGroupA), and/or (b) the pathloss is less than a value derived by the parameters configured in the RA configuration for the 2-step RA. The value may be derived by PCMAX (e.g., of the serving cell performing the Random Access Procedure)−msgA-preambleReceivedTargetPower−msgA-DeltaPreamble−messagePowerOffsetGroupB.

In some implementations, the UE may select the RA preambles group B in the RA procedure with the 2-step RA type if the UE determines that (a) the RA procedure was initiated for the CCCH logical channel, and/or (b) the CCCH SDU size plus MAC subheader is greater than an RA-MsgA-size-groupA (e.g., based on the IE ra-MsgA-SizeGroupA).

In some implementations, the UE may select the same group of RA Preambles as was used for the RA Preamble transmission attempt corresponding to the first transmission of MSGA in the RA procedure with the 2-step RA type when the RA Preambles group has been selected (e.g., during the current RA procedure). In some implementations, the UE may select the same group of RA Preambles as was used for the RA Preamble transmission attempt corresponding to the first transmission of MSGA if the UE determines that the RA Preambles group has been selected (e.g., during the current RA procedure).

The RA type of an RA procedure may be switched from the 2-step RA type to the 4-step RA type. In some implementations, if the RA type of an RA procedure is switched from the 2-step RA type to the 4-step RA type, and/or if the RA Preambles group was not selected during the (current) RA procedure, the UE may select the RA preambles group B in the RA procedure when one or more of the following conditions (a) and (b) are satisfied. Otherwise, the UE may select group A.

(a): The RA Preambles group B is configured.

(b): The transport block size of the MSGA payload configured in the rach-ConfigDedicated corresponds to the transport block size of the MSGA payload associated with the Random Access Preambles group B.

In some implementations, the UE may select the RA preambles group B if the UE determines that (a) the RA Preambles group B is configured, and/or (b) the transport block size of the MSGA payload configured in the rach-ConfigDedicated corresponds to the transport block size of the MSGA payload associated with the Random Access Preambles group B.

In some implementations, if the RA type of an RA procedure is switched from the 2-step RA type to the 4-step RA type, the UE may select the same group of RA Preambles as was selected for the 2-step RA type in the RA procedure when an RA Preambles group was selected during the (current) RA procedure. In some implementations, the UE may select the same group of RA Preambles as was selected for the 2-step RA type if an RA Preambles group was selected during the (current) RA procedure. In some implementations, the UE may select the same group of RA Preambles for the 2-step RA type of the (current) RA procedure as what is selected for the 4-step RA type of the (current) RA procedure. The 2-step RA type and the 4-step RA type may belong to the same RA procedure.

RA Preambles Group Selection in SDT

A UE (e.g., the RRC layer of the UE) in the RRC_INACTIVE state may initiate an SDT procedure (e.g., the resume procedure for SDT, the RA-SDT, and/or the CG-SDT) when one or more of the following conditions (a)-(e) are satisfied.

(a) The upper layers/NAS layer of the UE requests resumption of the RRC connection (e.g., mo-data arrival from the upper layers).

(b) The UE supports SDT (e.g., based on the UE capability).

(c) The system information (e.g., SIB1 and/or other SI) include sdt-ConfigCommon.

(d) All the pending data in the UL is mapped to the radio bearers (e.g., SRB/DRB) configured for the SDT.

(e) The lower layers/MAC layer of the UE indicates that one or more conditions for initiating an SDT (e.g., as specified in the 3GPP TS 38.321) are satisfied. The lower layers/MAC layer may indicate that the conditions for initiating the SDT when the UE initiates an RA procedure (e.g., or SDT with CG type 1) on a selected UL carrier for SDT.

The SDT procedure may be initiated (e.g., by MAC layer of the UE) when one or more of the following conditions (a) and (b) are satisfied.

(a) If the data volume of the pending UL data across all the logical channels configured for SDT (e.g., associated with the RBs configured for the SDT), for example, based on a data volume calculation procedure (e.g., as specified in the 3GPP TS 38.322 and TS 38.323, and where the size of the RLC headers and MAC subheaders are not considered in the data volume computation) is less than or equal to sdt-DataVolumeThreshold.

(b) When the RSRP of the downlink pathloss reference is higher than an RSRP threshold (e.g., the sdt-RSRP-Threshold), if configured.

The UE may initiate an RA procedure for the SDT while the UE is in the RRC_INACTIVE state and/or while performing the SDT procedure. The RA procedure for SDT may be an RA procedure with the 4-step RA-SDT type or a 2-step RA-SDT type. The RA procedure for SDT may be a contention-based RA procedure. The UE may select/use the RA preamble/RA resource/PRACH resource which is configured for SDT to perform the RA preamble transmission. The UE may apply the RA configurations/IEs which are configured for SDT (e.g., via RACH-ConfigSDT, RACH-ConfigCommonSDT, RACH-ConfigTwoStepRASDT, RACH-ConfigCommonTwoStepSDT, MsgA-ConfigSDT, and/or MsgA-ConfigCommonSDT). The RA procedure may be initiated for a CCCH/DTCH/DCCH logical channel. The CCCH/DTCH/DCCH logical channel may be associated with the SRB/DRB(s) configured for SDT. The RA procedure may be initiated for the RRC connection resume.

In some implementations, when the UE is performing a 4-step RA-SDT procedure (e.g., an RA procedure with the 4-step RA-SDT type), the UE may determine whether to select the RA preambles group B in the 4-step RA-SDT procedure (e.g., an RA procedure with the 4-step RA-SDT type) based on one or more of the following conditions (a)-(o). In some implementations, the UE may also select the RA preambles group B when one or more of the following conditions (a)-(o) are satisfied. Otherwise, the UE may select the RA preambles group A.

(a): The UE is configured with the group B configuration for SDT (e.g., via the IE groupB-ConfiguredSDT).

(b): The RA procedure is initiated for SDT.

(c): The RA procedure is set to the 4-step RA-SDT type.

(d): The RA procedure was initiated for the CCCH/DTCH/DCCH logical channel.

The CCCH/DTCH DCCH may include specific assistance information for SDT. The specific assistance information may include information that indicates whether there is any non-SDT data arrival (e.g., at the UE). The CCCH/DTCH/DCCH logical channel may be associated with the SRB/DRB(s) that are configured for SDT. In some implementations, the RA procedure initiated for SDT (e.g., RA-SDT procedure) may be determined by the UE as not being initiated for the CCCH logical channel (e.g., even if the UE transmits data from the CCCH logical channel via an Msg3/MsgA).

(e): The CCCH/DTCH/DCCH SDU(s) size plus MAC subheader is greater than an SDT RA-Msg3-size-groupA (e.g., based on the IE sdt-ra-Msg3SizeGroupA).

(f): The data volume is higher/lower than a threshold.

The data volume may be calculated based on the data volume of the pending UL data across all the logical channels configured for SDT (e.g., associated with the RBs configured for SDT) based on a data volume calculation procedure (e.g., as specified in the 3GPP TS 38.322 and TS 38.323, and where the size of the RLC headers and MAC subheaders are not considered in the data volume computation). The threshold may be configured in the SDT configuration and/or the RA configuration for SDT. The data volume may be referred to as the sdt-DataVolumeThreshold.

(g): There is a subsequent transmission.

The UE may determine that there is a subsequent transmission if the data volume is higher than a threshold. The UE may determine that there is a subsequent transmission if the difference between the data volume and the Msg3 size is higher than a threshold (e.g., data volume−Msg3 size>a threshold). The threshold may be configured in the SDT configuration and/or the RA configuration for SDT. The data volume may be referred to as the sdt-DataVolumeThreshold.

(h): There is a specific content that would be included in the Msg3.

The specific content may include the CCCH/DTCH/DCCH SDU(s). The CCCH/DTCH/DCCH logical channel may be associated with the SRB/DRB(s) that are configured for SDT.

The specific content may include a specific MAC CE(s). The specific MAC CE may be a BSR MAC CE or a PHR MAC CE.

The specific content may include the specific assistance information. The specific assistance information may include information that indicates whether there is a non-SDT data arrival. For example, the RRC layer (or the NAS layer) of the UE may provide the specific assistance information in an RRC message (or a NAS message). The RRC layer (or the NAS layer) of the UE may forward the RRC message (or the NAS message) to the lower layer. The RRC layer (or the NAS layer) of the UE may encapsulate the RRC message (or the NAS message) into a CCCH/DTCH/DCCH SDU(s). The MAC layer of the UE may receive the CCCH/DTCH/DCCH SDU(s) including the RRC message (or the NAS message) that includes the specific assistance information.

The specific content may include the UL data associated with the SRB/DRB/LCH (e.g., configured for SDT).

(i): There is specific information (e.g., to be indicated to the NW).

The specific assistance information may be information that indicates whether there is a non-SDT data arrival.

(j): The potential Msg3 size (e.g., UL data available for transmission plus MAC subheader(s) and, where required, MAC CEs) is greater than an RA-Msg3-size-groupA threshold for SDT (e.g., based on the IE ra-Msg3 SizeGroupA included in the group B configuration for SDT).

The potential Msg3 may include CCCH/DTCH/DCCH SDU(s), MAC CEs, and/or MAC subheader. The CCCH/DTCH/DCCH logical channel may be associated with the SRB/DRB(s) configured for SDT. The potential Msg3 may include specific assistance information. The specific assistance information may include information that indicates whether there is a non-SDT data arrival.

(k): The pathloss is less than a value derived by the parameters configured in the RA configuration for SDT.

The value may be derived by PCMAX (e.g., of the Serving Cell performing the Random Access Procedure)−preambleReceivedTargetPower−msg3-DeltaPreamble−messagePowerOffsetGroupB.

(l): The RA procedure was initiated for the CCCH logical channel.

In some implementations, the RA procedure initiated for SDT (e.g., RA-SDT procedure) may be determined by the UE as not being initiated for the CCCH logical channel (e.g., even if the UE transmits data from the CCCH logical channel via the Msg3/MsgA).

(m): The CCCH SDU size plus MAC subheader is greater than a SDT RA-Msg3-size-groupA (e.g., based on the IE sdt-ra-Msg3SizeGroupA).

(n): The Msg3 buffer is empty.

(o): The Msg3 is being retransmitted.

In some implementations, the UE may select the RA preambles group B (e.g., in the 4-step RA-SDT procedure) if the UE determines that (a) the UE is configured with the group B configuration for SDT (e.g., via the IE groupB-ConfiguredSDT), (b) the RA procedure is initiated for SDT, (c) the RA procedure is set to the 4-step RA-SDT type, (d) the RA procedure was initiated for the CCCH/DTCH/DCCH logical channel, and/or (e) the pathloss is less than a value derived by the parameters configured in the RA configuration for SDT.

In some implementations, the UE may select the RA preambles group B (e.g., in the 4-step RA-SDT procedure) if the UE determines that (a) the UE is configured with the group B configuration for SDT (e.g., via an IE groupB-ConfiguredSDT), (b) the RA procedure is initiated for SDT, (c) the RA procedure is set to the 4-step RA-SDT type, (d) the CCCH/DTCH/DCCH SDU(s) size plus MAC subheader is greater than an SDT RA-Msg3-size-groupA (e.g., based on the IE sdt-ra-Msg3SizeGroupA), and/or (e) the pathloss is less than a value derived by the parameters configured in the RA configuration for SDT.

In some implementations, the UE may select the RA preambles group B (e.g., in the 4-step RA-SDT procedure) if the UE determines that (a) the UE is configured with the group B configuration for SDT (e.g., via an IE groupB-ConfiguredSDT), (b) the RA procedure is initiated for SDT, (c) the RA procedure is set to the 4-step RA-SDT type, (d) a data volume is higher/lower than a threshold, and/or (e) the pathloss is less than a value derived by the parameters configured in the RA configuration for SDT.

In some implementations, the UE may select the RA preambles group B (e.g., in the 4-step RA-SDT procedure) if the UE determines that (a) the UE is configured with the group B configuration for SDT (e.g., via an IE groupB-ConfiguredSDT), (b) the RA procedure is initiated for SDT, (c) the RA procedure is set to the 4-step RA-SDT type, (d) the potential Msg3 size (e.g., UL data available for transmission plus MAC subheader(s) and, where required, MAC CEs) is greater than an RA-Msg3-size-groupA threshold for SDT (e.g., based on the IE ra-Msg3SizeGroupA included in the group B configuration for SDT), and/or (e) the pathloss is less than a value derived by the parameters configured in the RA configuration for SDT. The potential Msg3 may include CCCH/DTCH/DCCH SDU(s), MAC CEs, and/or MAC subheader. The potential Msg3 may include specific assistance information. The specific assistance information may include information that indicates whether there is a non-SDT data arrival.

In some implementations, when the UE is performing a the 4-step RA-SDT procedure (e.g., an RA procedure with the 4-step RA-SDT type), the UE may determine whether to select the same group of RA preambles as was used for the RA Preamble transmission attempt corresponding to the first transmission of the Msg3 based on one or more of the following conditions (a)-(d). In some implementations, the UE may select the same group of RA preambles as was used for the RA Preamble transmission attempt corresponding to the first transmission of Msg3 also when one or more of the following conditions (a)-(d) are satisfied.

(a): The Msg3 is being retransmitted.

(b): The RA Preambles group has been selected (e.g., during the current RA procedure).

(c): The RA type is not changed/switched (e.g., the current RA type is the same as the RA type when selecting the group of RA preambles last time in the current RA procedure).

(d): The RA procedure is the same RA procedure when the same group RA preambles was chosen.

In some implementations, the UE may select the same group of RA Preambles as was used for the RA Preamble transmission attempt corresponding to the first transmission of the Msg3 if the UE determines that (a) the Msg3 is being retransmitted, and/or (b) the RA type is not changed/switched (e.g., the RA type is the same as the RA type when selecting the group of RA preambles last time in the current RA procedure).

In some implementations, the UE may select the same group of RA Preambles as was used for the RA Preamble transmission attempt corresponding to the first transmission of Msg3 if the UE determines that (a) the RA Preambles group has been selected (e.g., during the current RA procedure), and/or (b) the RA type is not changed/switched (e.g., the current RA type is the same as the RA type when selecting the group of RA preambles last time in the current RA procedure).

In some implementations, when the UE is performing a 2-step RA-SDT procedure (e.g., an RA procedure with the 2-step RA-SDT type), the UE may determine whether to select the RA preambles group B in the 2-step RA-SDT procedure (e.g., an RA procedure with the 2-step RA-SDT type) based on one or more of the following conditions (a)-(p). In some implementations, the UE may select the RA preambles group B in the 2-step RA-SDT procedure when one or more of the following conditions (a)-(p) are satisfied. Otherwise, the UE may select the RA preambles group A.

(a) The UE is configured with the group B configuration for the 2-step RA SDT (e.g., via an IE groupB-ConfiguredTwoStepRA-SDT).

(b) The RA procedure is initiated for SDT.

(c) The RA procedure is set to the 2-step RA-SDT type.

(d) The RA procedure was initiated for the CCCH/DTCH/DCCH logical channel.

The CCCH/DTCH DCCH may include specific assistance information for SDT. The specific assistance information may include information that indicates whether there is a non-SDT data arrival. The CCCH/DTCH/DCCH logical channel may be associated with the SRB/DRB(s) configured for SDT. In some implementations, the RA procedure initiated for SDT (e.g., RA-SDT procedure) may be determined by the UE as not being initiated for the CCCH logical channel (e.g., even if the UE transmits data from the CCCH logical channel via an Msg3/MsgA).

(e) The CCCH/DTCH/DCCH SDU(s) size plus MAC subheader is greater than an SDT RA-MsgA-size-groupA (e.g., based on the IE sdt-ra-MsgASizeGroupA).

(f) The data volume is higher/lower than a threshold.

The data volume may be calculated based on the data volume of the pending UL data across all the logical channels configured for SDT (e.g., associated with the RBs configured for SDT) based on a data volume calculation procedure (e.g., as specified in the 3GPP TS 38.322 and TS 38.323, and where the size of the RLC headers and MAC subheaders are not considered in the data volume computation.) The threshold may be configured in the SDT configuration and/or the RA configuration for SDT. The data volume may be referred to as the sdt-DataVolumeThreshold.

(g) There is a subsequent transmission.

The UE may determine that there is a subsequent transmission if the data volume is higher than a threshold. The UE may determine that there is a subsequent transmission if the difference between the data volume and the MsgA payload size is higher than a threshold (e.g., data volume−MsgA payload size>a threshold). The threshold may be configured in the SDT configuration and/or the 2-step RA configuration for SDT. The data volume may be referred to as the sdt-DataVolumeThreshold.

(h) There is a specific content that may be included in the MsgA.

The specific content may include the CCCH/DTCH/DCCH SDU(s). The CCCH/DTCH/DCCH logical channel may be associated with the SRB/DRB(s) configured for SDT.

The specific content may include a specific MAC CE(s). The specific MAC CE may be a BSR MAC CE or a PHR MAC CE.

The specific content may include the specific assistance information. The specific assistance information may include information that indicates whether there is a non-SDT data arrival. For example, the RRC layer (or the NAS layer) of the UE may provide the specific assistance information in an RRC message (or a NAS message). The RRC layer (or the NAS layer) of the UE may forward the RRC message (or the NAS message) to the lower layer. The RRC layer (or the NAS layer) of the UE may encapsulate the RRC message (or the NAS message) into a CCCH/DTCH/DCCH SDU(s). The MAC layer of the UE may receive the CCCH/DTCH/DCCH SDU(s) including the RRC message (or the NAS message) that includes the specific assistance information.

The specific content may include the UL data associated with the SRB/DRB/LCH (e.g., for SDT).

(i) There is specific information (e.g., to be indicated to the NW).

The specific assistance information may include information that indicates whether there is a non-SDT data arrival.

(j) The potential MSGA payload size (e.g., UL data available for transmission plus MAC subheader(s) and, where required, MAC CEs) is greater than an RA-MsgA-size-groupA threshold for SDT (e.g., based on the IE ra-MsgASizeGroupA included in the group B configuration for SDT). The potential MsgA may include CCCH/DTCH/DCCH SDU(s), MAC CEs, and/or MAC subheader. The CCCH/DTCH/DCCH logical channel may be associated with the SRB/DRB(s) configured for SDT. The potential MsgA may include specific assistance information. The specific assistance information may be an information that indicates whether there is a non-SDT data arrival.

(k) The pathloss is less than a value derived by the parameters configured in the 2-step RA configuration for SDT, the RA configuration for SDT, and/or a common RA configuration for SDT.

The value may be derived by PCMAX (e.g., of the Serving Cell performing the Random Access Procedure)−msgA-preambleReceivedTargetPower−msgA-DeltaPreamble−messagePowerOffsetGroupB.

(l) The RA procedure was initiated for the CCCH logical channel.

In some implementations, the RA procedure that is initiated for SDT (e.g., an RA-SDT procedure) may be determined by the UE as not being initiated for the CCCH logical channel (e.g., even if the UE transmits data from the CCCH logical channel via an Msg3/MsgA).

(m) The CCCH SDU size plus MAC subheader is greater than an SDT RA-MsgA-size-groupA (e.g., based on the IE sdt-ra-Msg3SizeGroupA).

(n) The RA Preambles group has not yet been selected.

(o) The RA Preambles group has been selected.

(p) The contention-free RA Resources for the 2-step RA type have not been configured.

In some implementations, the UE may select the RA preambles group B (e.g., in the 2-step RA-SDT procedure) if the UE determines that (a) the UE is configured with the group B configuration for the 2-step RA SDT (e.g., via an IE groupB-ConfiguredTwoStepRA-SDT), (b) the RA procedure is initiated for SDT, (c) the RA procedure is set to the 2-step RA-SDT type, (d) the RA procedure was initiated for the CCCH/DTCH/DCCH logical channel, and/or (e) the pathloss is less than a value derived by the parameters configured in the 2-step RA configuration for SDT, RA configuration for SDT, and/or a common RA configuration for SDT.

In some implementations, the UE may select the RA preambles group B (e.g., in the 2-step RA-SDT procedure) if the UE determines that (a) the UE is configured with the group B configuration for the 2-step RA SDT (e.g., via the IE groupB-ConfiguredTwoStepRA-SDT), (b) the RA procedure is initiated for SDT, (c) the RA procedure is set to the 2-step RA-SDT type, (d) the CCCH/DTCH/DCCH SDU(s) size plus MAC subheader is greater than a SDT RA-MsgA-size-groupA (e.g., based on the IE sdt-ra-MsgASizeGroupA), and/or (e) the pathloss is less than a value derived by the parameters configured in the 2-step RA configuration for SDT, the RA configuration for SDT, and/or a common RA configuration for SDT.

In some implementations, the UE may select the RA preambles group B (e.g., in the 2-step RA-SDT procedure) if the UE determines that (a) the UE is configured with the group B configuration for the 2-step RA SDT (e.g., via an IE groupB-ConfiguredTwoStepRA-SDT), (b) the RA procedure is initiated for SDT, (c) the RA procedure is set to the 2-step RA-SDT type, (d) a data volume is higher/lower than a threshold, and/or (e) the pathloss is less than a value derived by the parameters configured in the RA configuration for SDT, the RA configuration for SDT, and/or a common RA configuration for SDT.

In some implementations, the UE may select the RA preambles group B (e.g., in the 2-step RA-SDT procedure) if the UE determines that (a) the UE is configured with the group B configuration for the 2-step RA SDT (e.g., via an IE groupB-ConfiguredTwoStepRA-SDT), (b) the RA procedure is initiated for SDT, (c) the RA procedure is set to the 2-step RA-SDT type, (d) the potential MsgA payload size (e.g., UL data available for transmission plus MAC subheader(s) and, where required, MAC CEs) is greater than an RA-MsgA-size-groupA threshold for SDT (e.g., based on the IE ra-Msg3 SizeGroupA included in the group B configuration for SDT), and/or (e) the pathloss is less than a value derived by the parameters configured in the RA configuration for SDT, the RA configuration for SDT, and/or a common RA configuration for SDT. The potential MsgA payload may include CCCH/DTCH/DCCH SDU(s), MAC CEs, and/or MAC subheader. The potential MsgA payload may include specific assistance information. The specific assistance information may include information that indicates whether there is a non-SDT data arrival.

In some implementations, when the UE is performing a 2-step RA-SDT procedure (e.g., an RA procedure with the 2-step RA-SDT type), the UE may determine whether to select the same group of RA preambles as was used for the RA Preamble transmission attempt corresponding to the first transmission of MSGA based on one or more of the following conditions (a)-(d). In some implementations, the UE may select the same group of RA preambles as was used for the RA Preamble transmission attempt corresponding to the first transmission of MSGA also when one or more of the following conditions (a)-(d) are satisfied.

(a): The MsgA is being retransmitted.

(b): The RA Preambles group has been selected (e.g., during the current RA procedure).

(c): The RA type is not changed/switched (e.g., the current RA type is the same as the RA type when selecting the group of RA preambles last time in the current RA procedure).

(d): The RA procedure is the same RA procedure when the same group of RA preambles was chosen.

In some implementations, the UE may select the same group of RA Preambles as was used for the RA Preamble transmission attempt corresponding to the first transmission of MsgA if the UE determines that (a) the MsgA is being retransmitted, and/or (b) the RA type is not changed/switched (e.g., the current RA type is the same as the RA type when selecting the group of RA preambles last time in the current RA procedure).

In some implementations, the UE may select the same group of RA Preambles as was used for the RA Preamble transmission attempt corresponding to the first transmission of MsgA if the UE determines that (a) the RA Preambles group has been selected (e.g., during the current RA procedure), and/or (b) the RA type is not changed/switched (e.g., the current RA type is the same as the RA type when selecting the group of RA preambles last time in the current RA procedure).

The RA type of an RA procedure may be switched from the 2-step RA-SDT type to the 4-step RA-SDT type. In some implementations, when the UE is performing an RA-SDT procedure, and if the RA type is switched from the 2-step RA-SDT type to the 4-step RA-SDT type, and/or RA Preambles group was not selected during the (current) RA-SDT procedure, the UE may determine whether to select the RA preambles group B in the RA-SDT procedure based on one or more of the following conditions (a)-(n). In some implementations, the UE may select the RA preambles group B in the RA-SDT procedure also when one or more of the following conditions (a)-(n) are satisfied. Otherwise, the UE may select the RA preambles group A.

(a): The RA Preambles group B (e.g., for SDT) is configured (e.g., via the IE groupB-ConfiguredSDT).

(b): The TB size of the MSGA payload configured in a (2-step) RA configuration for SDT corresponds to the TB size of the MSGA payload associated with the RA Preambles group B.

The (2-step) RA configuration for SDT may be configured by RACH-ConfigSDT, RACH-ConfigCommonSDT, RACH-ConfigTwoStepRASDT, RACH-ConfigCommonTwoStepSDT, MsgA-ConfigSDT, and/or MsgA-ConfigCommonSDT).

The (2-step) RA configuration for SDT may be configured by the system information (e.g., SIB1 or in other SI in the NR protocols). The RA configuration for SDT may be configured by a common SDT configuration (e.g., the sdt-ConfigCommon). The UE may receive the system information (e.g., SIB1 or in other SI in the NR protocols) including the common SDT configuration. The group B configuration for SDT may be a cell-specific parameter.

The (2-step) RA configuration for SDT may be configured by a dedicated RRC configuration. The RA configuration for SDT may be configured by an SDT configuration (e.g., the sdt-Config). The UE may receive an RRC message (e.g., an RRC release message with suspend configuration) including the SDT configuration. The RA configuration for SDT may be configured by an RRC release message (e.g., and/or suspend configuration).

The (2-step) RA configuration for SDT may (only) be configured if the UE is configured with a feature combination indication for SDT. A field of SDT in the feature combination indication may be set as “true.” A field of the SDT in the feature combination indication may be indicated. The feature combination indication may include (but is not limited to) fields/features of Reduced Capability, Small Data, RAN slicing, and/or coverage enhancement.

(c): The RA procedure is initiated for SDT.

(d): The RA procedure is set to the 4-step RA-SDT type.

(e): The RA procedure was initiated for the CCCH/DTCH/DCCH logical channel.

The CCCH/DTCH/DCCH SDU(s) may include specific assistance information for SDT. The specific assistance information may include information that indicates whether there is a non-SDT data arrival. For example, the RRC layer (or the NAS layer) of the UE may provide the specific assistance information in an RRC message (or a NAS message). The RRC layer (or the NAS layer) of the UE may forward the RRC message (or the NAS message) to the lower layer. The RRC layer (or the NAS layer) of the UE may encapsulate the RRC message (or the NAS message) into a CCCH/DTCH/DCCH SDU(s). The MAC layer of the UE may receive the CCCH/DTCH/DCCH SDU(s) including the RRC message (or the NAS message) that includes the specific assistance information. The CCCH/DTCH/DCCH logical channel may be associated with the SRB/DRB(s) configured for SDT.

In some implementations, the RA procedure initiated for SDT (e.g., the RA-SDT procedure) may be determined by the UE as not being initiated for the CCCH logical channel (e.g., even if the UE transmits data from the CCCH logical channel via an Msg3/MsgA).

(f): The CCCH/DTCH/DCCH SDU(s) size plus MAC subheader is greater than an SDT RA-Msg3-size-groupA (e.g., based on the IE sdt-ra-Msg3SizeGroupA).

(g): The data volume is higher/lower than a threshold.

The data volume may be calculated based on the data volume of the pending UL data across all the logical channels configured for SDT (e.g., associated with the RBs configured for SDT) based on a data volume calculation procedure (e.g., as specified in the 3GPP TS 38.322 and TS 38.323, and where the size of the RLC headers and MAC subheaders are not considered in the data volume computation). The threshold may be configured in the SDT configuration and/or the RA configuration for SDT. The data volume may be referred to as the sdt-DataVolumeThreshold.

(h): There is a subsequent transmission.

The UE may determine that there is a subsequent transmission if the data volume is higher than a threshold. The UE may determine there is a subsequent transmission if the difference between the data volume and the Msg3 size is higher than a threshold (e.g., data volume−Msg3 size>a threshold). The threshold may be configured in the SDT configuration and/or the RA configuration for SDT. The data volume may be referred to as the sdt-DataVolumeThreshold.

(i): There is a specific content that may be included in the Msg3.

The specific content may include the CCCH/DTCH/DCCH SDU(s). The CCCH/DTCH/DCCH logical channel may be associated with the SRB/DRB(s) configured for SDT.

The specific content may include a specific MAC CE(s). The specific MAC CE may be a BSR MAC CE or a PHR MAC CE.

The specific content may include specific assistance information. The specific assistance information may include information to indicate whether there is a non-SDT data arrival. For example, the RRC layer (or the NAS layer) of the UE may provide the specific assistance information in an RRC message (or a NAS message). The RRC layer (or the NAS layer) of the UE may forward the RRC message (or the NAS message) to the lower layer. The RRC layer (or the NAS layer) of the UE may encapsulate the RRC message (or the NAS message) into a CCCH/DTCH/DCCH SDU(s). The MAC layer of the UE may receive the CCCH/DTCH/DCCH SDU(s) including the RRC message (or the NAS message) that includes the specific assistance information.

The specific content may include the UL data associated with the SRB/DRB/LCH (e.g., for SDT).

(j): There is specific information (e.g., to be indicated to the NW).

The specific assistance information may include information that indicates whether there is a non-SDT data arrival.

(k): The potential Msg3 size (e.g., UL data available for transmission plus MAC subheader(s) and, where required, MAC CEs) is greater than an RA-Msg3-size-groupA threshold for SDT (e.g., based on the IE ra-Msg3 SizeGroupA included in the group B configuration for SDT).

The potential Msg3 may include CCCH/DTCH/DCCH SDU(s), MAC CEs, and/or MAC subheader. The CCCH/DTCH/DCCH logical channel may be associated with the SRB/DRB(s) configured for SDT. The potential Msg3 may include specific assistance information. The specific assistance information may include information that indicates whether there is a non-SDT data arrival.

(l): The pathloss is less than a value derived by the parameters configured in the RA configuration for SDT.

The value may be derived by PCMAX (e.g., of the Serving Cell performing the Random Access Procedure)−preambleReceivedTargetPower−msg3-DeltaPreamble−messagePowerOffsetGroupB.

(m): The RA procedure was initiated for the CCCH logical channel.

In some implementations, the RA procedure initiated for SDT (e.g., the RA-SDT procedure) may be determined by the UE as not being initiated for the CCCH logical channel (e.g., even if the UE transmits data from the CCCH logical channel via an Msg3/MsgA).

(n): The CCCH SDU size plus MAC subheader is greater than an SDT RA-Msg3-size-groupA (e.g., based on the IE sdt-ra-Msg3SizeGroupA).

In some implementations, when the UE is performing an RA-SDT procedure, the RA type is switched from the 2-step RA-SDT type to the 4-step RA-SDT type, and/or RA Preambles group was not selected during the (current) RA-SDT procedure, the UE may select the RA preambles group B if the UE determines that (a) the RA Preambles group B (e.g., for SDT) is configured (e.g., via an IE groupB-ConfiguredSDT), and/or (b) the TB size of the MSGA payload configured in a (2-step) RA configuration for SDT corresponds to the TB size of the MSGA payload associated with the RA Preambles group B.

In some implementations, when the UE is performing an RA-SDT procedure, the RA type is switched from the 2-step RA-SDT type to the 4-step RA-SDT type, and/or RA Preambles group was not selected during the (current) RA-SDT procedure, the UE may select the RA preambles group B if the UE determines that (a) RA Preambles group B (e.g., for SDT) is configured (e.g., via an IE groupB-ConfiguredSDT), (b) the RA procedure is initiated for SDT, (c) the RA procedure was initiated for the CCCH/DTCH/DCCH logical channel, and/or (d) the pathloss is less than a value derived by the parameters configured in the RA configuration for SDT.

In some implementations, when the UE is performing an RA-SDT procedure, the RA type is switched from the 2-step RA-SDT type to the 4-step RA-SDT type, and/or RA Preambles group was not selected during the (current) RA-SDT procedure, the UE may select the RA preambles group B if the UE determines that (a) RA Preambles group B (e.g., for SDT) is configured (e.g., via an IE groupB-ConfiguredSDT), (b) the RA procedure is initiated for SDT, (c) the data volume is higher/lower than a threshold, and/or (d) the pathloss is less than a value derived by the parameters configured in the RA configuration for SDT.

In some implementations, when the UE is performing an RA-SDT procedure, and if the RA type is switched from the 2-step RA-SDT type to the 4-step RA-SDT type, and/or RA Preambles group was selected during the (current) RA-SDT procedure, the UE may determine to select the same group of RA preambles (as was selected for the 2-step RA-SDT type).

The RA type of an RA procedure may be switched from the 4-step RA-SDT/2-step RA-SDT type to the 4-step RA/2-step RA type. In some implementations, the UE may initiate a first RA procedure and set the RA type of the first RA procedure to the 4-step RA-SDT/2-step RA-SDT type, then the UE may keep performing the first RA procedure and set the RA type of the first RA procedure to the 4-step RA/2-step RA type in some implementations. In some implementations, the UE may initiate a first RA procedure (e.g., for SDT) and set the RA type of the first RA procedure to the 4-step RA-SDT/2-step RA-SDT type, then the UE may terminate/stop the first RA procedure (e.g., for SDT). After the UE terminates/stops the first RA procedure (e.g., for SDT), the UE may initiate a second RA procedure (e.g., not for the SDT) and set the RA type of the second RA procedure to the 4-step RA/2-step RA type in some implementations.

In some implementations, when the UE is performing a first RA procedure, and if the RA type is switched from the 4-step RA-SDT/2-step RA-SDT type to the 4-step RA/2-step RA type, and/or RA Preambles group was not selected during the first RA procedure, the UE may determine whether to select the RA preambles group B in the first RA procedure based on the following Condition. In some implementations, the UE may determine to select the RA preambles group B in the first RA procedure when the following Condition is satisfied. Otherwise, the UE may select the RA preambles group A (e.g., when the following Condition is not satisfied).

Condition: the UE reselects the RA preambles group in the first RA procedure no matter whether the UE selected an RA Preambles group in the first RA procedure or not.

In some implementations, when the UE is performing a first RA procedure, and if the RA type is switched from the 4-step RA-SDT/2-step RA-SDT type to the 4-step RA/2-step RA type and the UE needs to perform a first RA preambles group selection, the UE may select the RA preambles group A or RA preambles group B as a result of the first RA preambles group selection. The UE may not need to consider whether another RA preambles group selection was performed before the first RA preambles group selection. The RA type may be switched from the 4-step RA-SDT/2-step RA-SDT type to the 4-step RA/2-step RA type when one or more of the following switching conditions (a)-(d) are satisfied.

(a): A number of preamble/msgA/msg3/RLC PDU transmissions reach a specific threshold before the RA type switching.

(b): A specific timer expires, wherein the specific timer is for receiving a response from the NW in response of a preamble/MsgA/msg3/RLC PDU transmission before the RA type switching.

(c): The TBS of an UL resource indicated in MSGB/RAR cannot be mapped to the pending UL data and/or the MAC CE before the RA type switching.

(d): The TBS of an UL resource indicated in MSGB/RAR is not equal to a specific threshold or is larger than/smaller than a specific threshold. The specific threshold may be a data volume threshold for selection between SDT and non-SDT or a threshold for determining the preamble group for SDT.

In some implementations, the UE may initiate a first RA procedure (e.g., for SDT) and set the RA type of the first RA procedure to the 4-step RA-SDT/2-step RA-SDT type, then the UE may terminate/stop the first RA procedure (e.g., for SDT). After the UE terminates/stops the first RA procedure (e.g., for SDT), the UE may initiate a second RA procedure (e.g., not for the SDT) and set the RA type of the second RA procedure to the 4-step RA/2-step RA type, and the UE may determine whether to select the RA preambles group B in the second RA procedure based on the following Condition. In some implementations, the UE may determine to select the RA preambles group B in the second RA procedure when the following Condition is satisfied. Otherwise, the UE may select the RA preambles group A (e.g., when the following Condition is not satisfied.)

Condition: the UE reselects the RA preambles group in the first RA procedure no matter whether the UE selected an RA Preambles group in the first RA procedure or not.

In some implementations, the UE may initiate a first RA procedure (e.g., for SDT) and set the RA type of the first RA procedure to the 4-step RA-SDT/2-step RA-SDT type. Subsequently, the UE may terminate/stop the first RA procedure (e.g., for SDT), initiate a second RA procedure (e.g., not for the SDT), and set the RA type of the second RA procedure to the 4-step RA/2-step RA type. When the second RA procedure (e.g., not for the SDT) is initiated, the UE may select the RA preambles group A. The UE may terminate/stop the first RA procedure, initiate a second RA procedure (e.g., not for the SDT), and set the RA type of the second RA procedure to the 4-step RA/2-step RA type when one or more of the following conditions (a)-(r) are satisfied.

(a): RA Preambles group B (e.g., for SDT) is configured (e.g., via an IE groupB-Configured and/or groupB-ConfiguredSDT).

(b): The TB size of the Msg3/MSGA payload configured in a (2-step) RA configuration for SDT corresponds to the TB size of the Msg3/MSGA payload associated with the RA Preambles group B.

(c): The RA procedure is initiated for the SDT.

(d): The RA procedure was initiated for the CCCH/DTCH/DCCH logical channel.

The CCCH/DTCH DCCH may include specific assistance information for SDT. The specific assistance information may include information that indicates whether there is a non-SDT data arrival. The CCCH/DTCH/DCCH logical channel may be associated with the SRB/DRB(s) configured for SDT.

In some implementations, the RA procedure initiated for SDT (e.g., the RA-SDT procedure) may be determined by the UE as not being initiated for the CCCH logical channel (e.g., even if the UE transmits data from the CCCH logical channel via an Msg3/MsgA).

(e): The CCCH/DTCH/DCCH SDU(s) size plus MAC subheader is greater than an SDT RA-Msg3/MsgA-size-groupA (e.g., based on the IE sdt-ra-Msg3/MsgASizeGroupA).

(f): A data volume is higher/lower than a threshold.

The data volume may be calculated based on the data volume of the pending UL data across all the logical channels configured for SDT (e.g., associated with the RBs configured for SDT) based on a data volume calculation procedure (e.g., as specified in the 3GPP TS 38.322 and TS 38.323, and where the size of the RLC headers and MAC subheaders are not considered in the data volume computation). The threshold may be configured in the SDT configuration and/or the RA configuration for SDT. The data volume may be referred to sdt-DataVolumeThreshold.

(g): There is a subsequent transmission.

The UE may determine that there is a subsequent transmission if the data volume is higher than a threshold. The UE may determine that there is a subsequent transmission if the difference between the data volume and the Msg3/MsgA payload size is higher than a threshold (e.g., data volume−Msg3/MsgA payload size>a threshold). The threshold may be configured in the SDT configuration and/or the (2-step) RA configuration for SDT. The data volume may be referred to as the sdt-DataVolumeThreshold.

(h): There is a specific content that would be included in the Msg3/MsgA.

The specific content may include the CCCH/DTCH/DCCH SDU(s). The CCCH/DTCH/DCCH logical channel may be associated with the SRB/DRB(s) configured for SDT.

The specific content may include a specific MAC CE(s). The specific MAC CE may be a BSR MAC CE or a PHR MAC CE.

The specific content may include specific assistance information. The specific assistance information may include information that indicates whether there is a non-SDT data arrival.

The specific content may include the UL data associated with the SRB/DRB/LCH (e.g., for SDT).

(i): There is specific information (e.g., to be indicated to the NW).

The specific assistance information may include information that indicates there is a non-SDT data arrival.

(j): The potential Msg3/MsgA size (e.g., UL data available for transmission plus MAC subheader(s) and, where required, MAC CEs) is greater than an RA-Msg3/MsgA-size-groupA threshold (e.g., based on the IE ra-Msg3/MsgA SizeGroupA).

(k): The pathloss is less than a value derived by the parameters configured in the RA configuration.

The value may be derived by PCMAX (e.g., of the serving cell performing the Random Access Procedure)−preambleReceivedTargetPower/msgA-preambleReceivedTargetPower−msg3-DeltaPreamble/msgA-DeltaPreamble−messagePowerOffsetGroupB.

(l): The RA procedure was initiated for the CCCH logical channel.

In some implementations, the RA procedure initiated for SDT (e.g., the RA-SDT procedure) may be determined by the UE as not being initiated not being initiated for the CCCH logical channel (e.g., even if the UE transmits data from the CCCH logical channel via an Msg3/MsgA).

(m): The CCCH SDU size plus MAC subheader is greater than an RA-Msg3/MsgA-size-groupA (e.g., based on the IE ra-Msg3/MsgA SizeGroupA).

(n): Msg3/MsgA buffer is empty.

(o): The Msg3/MsgA payload is being retransmitted.

(p): The RA Preambles group has not yet been selected.

(q): The RA Preambles group has been selected.

(r): The contention-free RA Resources for the 2-step RA type have not been configured.

In some implementations, when the UE is performing a first RA procedure, and if the RA type is switched from the 4-step RA-SDT/2-step RA-SDT type to the 4-step RA/2-step RA type, and/or RA Preambles group was not selected during the first RA procedure, the UE may determine whether to select the RA preambles group B in the first RA procedure if the UE determines that (a) RA Preambles group B (e.g., for SDT) is configured (e.g., via an IE groupB-Configured and/or groupB-ConfiguredSDT), (b) the RA procedure is initiated for SDT, (c) the RA procedure was initiated for the CCCH/DTCH/DCCH logical channel, and/or (d) the Msg3/MsgA payload is being retransmitted.

In some implementations, when the UE is performing a first RA-SDT procedure, and if the RA type is switched from the 4-step RA-SDT/2-step RA-SDT type to the 4-step RA/2-step RA type, and/or RA Preambles group was selected during the first RA procedure, the UE may determine to select the same group of RA preambles (as was selected for the 4-step RA-SDT/2-step RA-SDT type). In some implementations, the UE may initiate a first RA procedure (e.g., for SDT) and set the RA type of the first RA procedure to the 4-step RA-SDT/2-step RA-SDT type, then the UE may terminate/stop the first RA procedure (e.g., for SDT). After the UE terminates/stops the first RA procedure (e.g., for SDT), the UE may initiate a second RA procedure (e.g., not for the SDT) and set the RA type of the second RA procedure to the 4-step RA/2-step RA type, the UE may determine whether to select the same group of RA preambles in the second RA procedure if RA Preambles group was selected during the first RA procedure.

In some implementations, the UE may initiate a CG-SDT procedure (e.g., for SDT), then the UE may terminate/stop the CG-SDT procedure. After the UE terminates/stops the CG-SDT procedure, the UE may initiate an RA-SDT/non-SDT RA procedure. The UE may determine whether to select the RA preambles group B in the RA-SDT/non-SDT RA procedure based on one or more of the following conditions (a)-(d). In some implementations, the UE may determine to select the RA preambles group B in the RA-SDT/non-SDT RA procedure when one or more of the following conditions (a)-(d) are satisfied. Otherwise, the UE may select the RA preambles group A.

(a): There is a specific content that would be included in the Msg3/MsgA (of a pending MAC PDU).

The specific content may include the CCCH/DTCH/DCCH SDU(s). The CCCH/DTCH/DCCH logical channel may be associated with the SRB/DRB(s) configured for SDT.

The specific content may include a specific MAC CE(s). The specific MAC CE may be a BSR MAC CE or a PHR MAC CE.

The specific content may include specific assistance information. The specific assistance information may include information that indicates whether there is a non-SDT data arrival.

The specific content may include the UL data associated with the SRB/DRB/LCH (e.g., for SDT).

The pending MAC PDU (including CCCH MAC SDU and SDT MAC SDU) may be referred to as a MAC PDU that was unsuccessfully transmitted during the CG-SDT. The pending MAC PDU may be transmitted on Msg3/MsgA.

(b): There is specific information (e.g., to be indicated to the NW).

The specific assistance information may include information that indicates there is a non-SDT data arrival.

(c): The Msg3/MsgA size or the size of a pending MAC PDU (e.g., UL data available for transmission plus MAC subheader(s) and, where required, MAC CEs) is greater than an RA-Msg3/MsgA-size-groupA threshold (e.g., based on the IE ra-Msg3/MsgA SizeGroupA). The Msg3/MsgA size is determined based on the data in the Msg3/MsgA buffer and/or the data in HARQ process 0.

The pending MAC PDU (including CCCH MAC SDU and SDT MAC SDU) may be referred to as a MAC PDU that was unsuccessfully transmitted during the CG-SDT. The pending MAC PDU may be transmitted on Msg3/MsgA.

(d): The pathloss is less than a value derived by the parameters configured in the RA configuration.

The value may be derived by PCMAX (e.g., of the serving cell performing the Random Access Procedure)−preambleReceivedTargetPower/msgA-preambleReceivedTargetPower−msg3-DeltaPreamble/msgA-DeltaPreamble−messagePowerOffsetGroupB.

UE Behaviors Upon Switching to Non-SDT RA

In some implementations, the UE may initiate a first RA procedure and set the RA type of the first RA procedure to the 4-step RA-SDT/2-step RA-SDT type, then the UE may keep performing the first RA procedure and set the RA type of the first RA procedure to the 4-step RA/2-step RA type in some implementations.

If the RA type of the first RA procedure is set to the 4-step RA-SDT/2-step RA-SDT type, the UE may select/use the RA preamble/RA resource/PRACH resource which is configured for SDT to perform the RA preamble transmission (e.g., based on RACH-ConfigSDT, RACH-ConfigCommonSDT, RACH-ConfigTwoStepRASDT, RACH-ConfigCommonTwoStepSDT, MsgA-ConfigSDT, and/or MsgA-ConfigCommonSDT). If the RA type of the first RA procedure is set to the 4-step RA/2-step RA type, the UE may select/use the RA preamble/RA resource/PRACH resource which is not configured for SDT to perform the RA preamble transmission (e.g., based on RACH-Config, RACH-ConfigCommon, RACH-ConfigTwoStepRA, RACH-ConfigCommonTwoStep, MsgA-Config, and/or MsgA-ConfigCommon).

If the RA type of the first RA procedure is set to the 4-step RA-SDT/2-step RA-SDT type, the UE may include data from the CCCH/DTCH/DCCH logical channel and/or the MAC CE(s) in the Msg3/MsgA. The CCCH/DTCH/DCCH logical channel may be associated with the SRB/DRB(s) configured for SDT. The data from the CCCH logical channel may be RRC resume request message. If the RA type of the first RA procedure is set to the 4-step RA/2-step RA type, the UE may (only) include data from the CCCH logical channel and/or the MAC CE(s) in the Msg3/MsgA. If the RA type of the first RA procedure is set to the 4-step RA/2-step RA type, the UE may not include data from DTCH/DCCH logical channel and/or the MAC CE(s) in the Msg3/MsgA.

The UE may perform one or more of the following actions (a)-(c) if the RA type of the first RA procedure is set to the 4-step RA/2-step RA type (e.g., from the 4-step RA-SDT/2-step RA-SDT type).

(a) Perform initialization of variables specific to the RA type.

(b) Flush or not flush the HARQ buffer used for the transmission of MAC PDU in the Msg3/MSGA buffer.

(c) Perform the Random Access Resource selection.

In some implementations, the UE may initiate a first RA procedure (e.g., for SDT) and set the RA type of the first RA procedure to the 4-step RA-SDT/2-step RA-SDT type, then the UE may terminate/stop the first RA procedure (e.g., for SDT). After the UE terminates/stops the first RA procedure (e.g., for SDT), the UE may initiate a second RA procedure (e.g., not for the SDT) and set the RA type of the second RA procedure to the 4-step RA/2-step RA type in some implementations.

In some implementations, the UE may initiate a CG-SDT procedure, then the UE may terminate/stop the CG-SDT procedure. After the UE terminates/stops the first RA procedure (e.g., for SDT), the UE may initiate a second RA procedure (e.g., not for the SDT) and set the RA type of the second RA procedure to the 4-step RA/2-step RA type in some implementations.

If the RA type of the first RA procedure is set to the 4-step RA-SDT/2-step RA-SDT type, the UE may select/use the RA preamble/RA resource/PRACH resource which is configured for SDT to perform the RA preamble transmission (e.g., based on RACH-ConfigSDT, RACH-ConfigCommonSDT, RACH-ConfigTwoStepRASDT, RACH-ConfigCommonTwoStepSDT, MsgA-ConfigSDT, and/or MsgA-ConfigCommonSDT). If the RA type of the second RA procedure is set to the 4-step RA/2-step RA type, the UE may select/use the RA preamble/RA resource/PRACH resource which is not configured for SDT to perform the RA preamble transmission (e.g., based on RACH-Config, RACH-ConfigCommon, RACH-ConfigTwoStepRA, RACH-ConfigCommonTwoStep, MsgA-Config, and/or MsgA-ConfigCommon).

If the RA type of the first RA procedure is set to the 4-step RA-SDT/2-step RA-SDT type, the UE may include data from the CCCH/DTCH/DCCH logical channel and/or the MAC CE(s) in the Msg3/MsgA. The CCCH/DTCH/DCCH logical channel may be associated with the SRB/DRB(s) configured for SDT. The data from the CCCH logical channel may be RRC resume request message. If the RA type of the second RA procedure is set to the 4-step RA/2-step RA type, the UE may (only) include data from the CCCH logical channel and/or the MAC CE(s) in the Msg3/MsgA. If the RA type of the first RA procedure is set to the 4-step RA/2-step RA type, the UE may not include data from DTCH/DCCH logical channel and/or the MAC CE(s) in the Msg3/MsgA.

The UE may not flush the HARQ buffer used for the transmission of MAC PDU in the Msg3/MSGA buffer and/or used for the transmission of the initial CG-SDT transmission (e.g., in CG-SDT procedure) when the UE initiates the second RA procedure (e.g., not for the SDT) and/or set the RA type of the second RA procedure to the 4-step RA/2-step RA type. The UE may not flush the Msg3/MSGA buffer when the UE initiates the second RA procedure (e.g., not for the SDT) and/or set the RA type of the second RA procedure to the 4-step RA/2-step RA type. The UE may not flush the HARQ buffer used for the transmission of MAC PDU in the Msg3/MSGA buffer and/or used for the transmission of the initial CG-SDT transmission (e.g., in a CG-SDT procedure) when the first RA procedure (e.g., for SDT) is terminated/stopped. The UE may not flush the Msg3/MSGA buffer when the first RA procedure (e.g., for SDT) is terminated/stopped.

UE Capability/UE Assistance Information

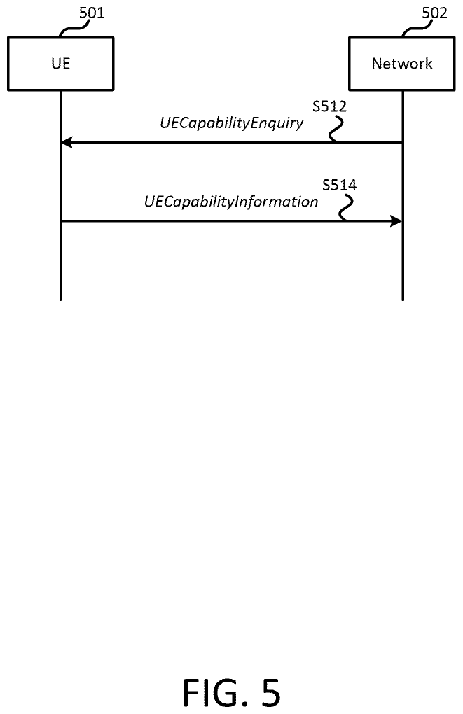

FIG. 5 is a diagram illustrating a process of a UE capability transfer, according to an example implementation of the present disclosure. The UE 501 may transfer the UE capability information (in action S514) upon receiving a UECapabilityEnquiry (in action S512) from the network 502. The network may initiate a procedure in the UE when the network needs (additional) UE radio access capability information. The network may retrieve the UE capabilities after an AS security activation. The network may not forward the UE capabilities that were retrieved before the AS security activation to the CN. The UE may report its UE radio access capabilities which are static at least when the network requests those information. The gNB may request about the capabilities of the UE to report based on the band information. The UE capability may be represented by a capability ID which may be exchanged in the NAS signaling over the air and in the network signaling instead of the UE capability structure. Upon reception of the UECapabilityEnquiry, the UE may set the contents of the UECapabilityInformation message. The UE may submit the UECapabilityInformation message to the lower layers for transmission (e.g., to the NW).

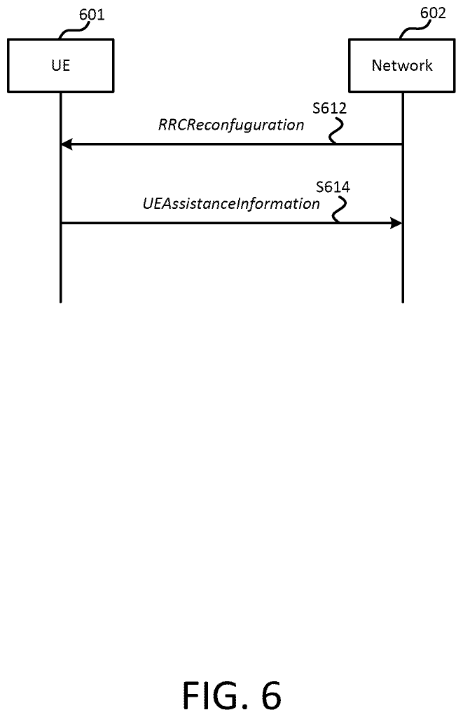

FIG. 6 is a diagram illustrating a process of a UE assistance information transfer, according to an example implementation of the present disclosure. If the UE 601 is configured to provide the UE assistance information via an RRCReconfiguration message (in action S612), the UE 601 may signal to the network (in action S614) its UE assistance information through, for example, the UEAssistanceInformation. The UE may set the contents of the UEAssistanceInformation message for the UE assistance information. The UE may submit the UEAssistanceInformation message to the lower layers for transmission (e.g., to the NW).

In some implementations, the UE may submit (to information for SDT to the NW via the UE capability information and/or the UE assistance information.

In some implementations, the UE may indicate whether the UE supports/prefers the RA-SDT (configuration), CG-SDT (configuration), and/or SDT to the NW via the UE capability information and/or the UE assistance information. If absent, the UE may not support the RA-SDT, CG-SDT, and/or SDT (e.g., in the RRC_INACTIVE state). In some implementations, the UE may indicate whether the UE supports/prefers the CG and/or the RA configuration on a dedicated BWP for SDT (e.g., in the RRC_INACTIVE state) to the NW by UE capability information and/or UE assistance information. If absent, the UE may support the CG and/or the RA configuration on the initial BWP for SDT (e.g., in the RRC_INACTIVE state). The dedicated BWP may be a specific BWP configured for SDT. The information (e.g., index) of the dedicated BWP may be indicated by an SDT configuration and/or a CG configuration of SDT. The dedicate BWP may be indicated by the bwp-ID. The dedicated BWP may not be an initial BWP. The initial BWP may be referred to as BWP #0. The initial BWP may be configured by the initialUplinkBWP and/or the initialDownlinkBWP.

In some implementations, the UE may indicate whether the UE supports/prefers more than one configured grant configuration for SDT (e.g., in the RRC_INACTIVE state) to the NW via the UE capability information and/or the UE assistance information. If absent, the UE may support one configured grant configuration for SDT (e.g., in the RRC_INACTIVE state). The CG configuration may be a type 1 CG. In some implementations, the UE may indicate whether the UE supports/prefers up to “X” configured/active configured grant configurations for SDT (e.g., in the RRC_INACTIVE state) to the NW via the UE capability information and/or the UE assistance information. “X” may be a maximum number of configured/active configured grant configurations. “X” may be the number of configured/active configured grant configurations that the UE intends to be configured. “X” may be lower or equal to a predefined maximum number of configured/active configured grant configurations.

In some implementations, the UE may indicate whether the UE supports/prefers LCH configuration and/or LCH restriction for SDT (e.g., in the RRC_INACTIVE state) to the NW via the UE capability information and/or the UE assistance information. If absent, the UE may not support LCH configuration and/or may not support LCH restriction for SDT (e.g., in the RRC_INACTIVE state). If the UE supports/prefers LCH configuration and/or LCH restriction for SDT (e.g., in the RRC_INACTIVE state), the UE may apply/store the first set of parameters for scheduling the UL data for each LCH (e.g., priority, prioritisedBitRate, and/or bucketSizeDuration). If the UE does not support/prefer LCH configuration and/or LCH restriction for SDT (e.g., in the RRC_INACTIVE state), the UE may not apply/store (or may ignore) the second set of parameters for the mapping restriction for each LCH (e.g., allowedSCS-List, maxPUSCH-Duration, configuredGrantType1Allowed, allowedServingCells, allowedCG-List, and/or allowedPHY-PriorityIndex).

In some implementations, the UE may indicate whether the UE supports/prefers restricting data transmission from a given LCH to a configured (sub-) set of configured grant configurations for SDT (e.g., in the RRC_INACTIVE state) to the NW via the UE capability information and/or the UE assistance information. The LCH may be associated with DRB/SRB configured for SDT. The CG configuration may be configured for SDT. The CG configuration may be type 1 CG. The UE capability information and/or UE assistance information may be associated with allowedSCS-List, maxPUSCH-Duration, configuredGrantType1Allowed, allowedServingCells, allowedCG-List, and/or allowedPHY-PriorityIndex. The UE capability information and/or UE assistance information may be indicated by lch-ToConfiguredGrantMapping for SDT (e.g., in the RRC_INACTIVE state).

In some implementations, the UE may indicate whether the UE supports/prefers the selection of logical channels for each UL grant based on RRC configured restriction using RRC parameters (e.g., allowedSCS-List, maxPUSCH-Duration, configuredGrantType1Allowed, allowedServingCells, and/or allowedCG-List) to NW by UE capability information and/or UE assistance information. The UE capability information and/or UE assistance information may be indicated by lcp-Restriction for SDT (e.g., in the RRC_INACTIVE state). The UE capability information and/or UE assistance information may be associated with allowedSCS-List, maxPUSCH-Duration, configuredGrantType1Allowed, allowedServingCells, allowedCG-List, and/or allowedPHY-PriorityIndex.

In some implementations, the UE may indicate whether the UE supports/prefers unlicensed band for SDT (e.g., in the RRC_INACTIVE state) to the NW via the UE capability information and/or the UE assistance information. If absent, the UE may support licensed band for SDT (e.g., in the RRC_INACTIVE state). In some implementations, a UE supporting unlicensed band for SDT (e.g., in the RRC_INACTIVE state) may also support cg-COT-SharingList, cg-COT-SharingOffset, cg-minDFI-Delay, cg-RetransmissionTimer, CG-COT-Sharing, and/or CG-StartingOffsets.

In some implementations, the UE may indicate whether the UE supports/prefers UE autonomous retransmission for SDT (e.g., in the RRC_INACTIVE state) to the NW via the UE capability information and/or the UE assistance information. If absent, the UE may not support UE autonomous retransmission for SDT (e.g., in the RRC_INACTIVE state). In some implementations, a UE supporting UE autonomous retransmission for SDT (e.g., in the RRC_INACTIVE state) may also support cg-RetransmissionTimer.

In some implementations, the UE may indicate whether the UE supports/prefers repetition for SDT (e.g., in the RRC_INACTIVE state) to the NW via the UE capability information and/or the UE assistance information. If absent, the UE may not support repetition for SDT (e.g., in the RRC_INACTIVE state). The proposed signaling may be transmitted to the serving RAN via SRB1 (e.g., via UEAssistanceInformation/UECapabilityInformation) or SRB3 (e.g., via UEAssistanceInformation) if secondary node/secondary cell group(s) is configured to the UE as part of multi-RAT configuration in the UE side.

In some implementations, the information for SDT (e.g., in the RRC_INACTIVE state) to the NW via the UE capability information and/or the UE assistance information may have different values between TDD and FDD. In some implementations, the information for SDT (e.g., in the RRC_INACTIVE state) to the NW by UE capability and/or UE assistance information may be reported for TDD or FDD. The information for SDT (e.g., in the RRC_INACTIVE state) to the NW via the UE capability information and/or the UE assistance information may have different values between FR1 and FR2. In some implementations, the information for SDT (e.g., in the RRC_INACTIVE state) to the NW by UE capability and/or UE assistance information may be reported for FR1 or FR2. At least one of the information for SDT (e.g., in the RRC_INACTIVE state) to the NW via the UE capability information and/or the UE assistance information, which is defined above, may be mandatorily presented.

SDT Assumptions

The SDT may be supported as a baseline for RA-based SDT and CG-based SDT schemes. The stored configuration in the UE Context may be used for the RLC bearer configuration. The 2-step RACH or the 4-step RACH may be applied to an RA-based SDT in the RRC_INACTIVE state. The UL small data may be sent in an MsgA of a 2-step RACH and/or an Msg3 of a 4-step RACH. The SDT may be configured by the network on a per RB (e.g., SRB/DRB) basis. The data volume threshold may be used for the UE to decide whether to perform/select an SDT procedure (e.g., initiate an SDT procedure, initiate an RA procedure for SDT, and/or initiate an SDT procedure with CG) or perform/select a non-SDT procedure (e.g., initiate an RA procedure for a CCCH logical channel). When the UE is in an RRC_INACTIVE state, the UE may send one or more UL and DL packets as part of the same SDT procedure and without transitioning to the RRC_CONNECTED state (e.g., the UE may remain in the RRC_INACTIVE state).

When the UE receives an RRC release message (e.g., with suspend configuration), the UE may perform the following actions (a)-(c).

(a) MAC entity may be reset, and default Radio bearer configuration may be released.

(b) RLC entities for SRB1 may be re-established.

(c) SRBs and DRBs may be suspended, except SRB0.

Upon initiating the SDT procedure (e.g., for the first transmission of small data), the UE may re-establish at least the PDCP entities (e.g., for SDT) and/or resume the RBs (e.g., for SDT). The first UL message of SDT (e.g., an Msg3 for a 4-step RACH, an MsgA payload for a 2-step RACH and/or the CG transmission) may include at least the following (a)-(d) (which may be depending on the size of the message).

(a) A CCCH message.

(b) Data from one or more RBs which are configured by the network for small data transmission.

(c) MAC CEs (e.g., BSR and PHR).

(d) Padding bits.

The LCP may be used to determine the priority of the following (a)-(c).

(a) Data from one or more RBs which are configured by the network for small data transmission.

(b) MAC CEs (e.g., BSR and PHR).

(c) Padding bits.

The CCCH message may include ResumeMAC-I generated using the stored security key for RRC integrity protection. New keys may be generated using the stored security context and the NCC value received in the previous RRC Release message, and the new keys may be used for generating the data of RBs that are configured for SDT.

For a CG-based SDT, the configuration of a CG resource for uplink small data transmission may be included in the RRC Release message. For a CG-based SDT, a TA timer (e.g., cg-SDT-TimeAlignmentTimer) for the TA maintenance specified for a CG based small data transmission in the RRC_INACTIVE state may be applied. The TA timer may be configured together with the CG configuration in the RRC Release message. For a CG-based SDT, the configuration of a CG resource for small data transmission may be valid only in the same serving cell (e.g., the configuration of the CG resource for small data transmission may be invalid if the UE camps on another cell). For the CG-based SDT, the UE may use a CG-based small data transmission if at least one of the following criteria (a)-(c) is fulfilled. (a) the user data is smaller than a data volume threshold; (b) the CG resource is configured and valid; (c) the UE has a valid TA.

For a CG-based SDT, an association between the CG resources and the SSBs may be required for a CG-based SDT. For a CG-based SDT, an SS-RSRP threshold may be configured for the SSB selection. The UE may select one of the SSBs with an SS-RSRP above the threshold and may select the associated CG resource for the UL data transmission. For a CG-based SDT, the CG-SDT resource configuration may be provided to the UEs that are in the RRC_CONNECTED state, for example, via the RRC Release message. For a CG-based SDT, the CG resources (e.g., PUSCH resources) may be separately configured for the NUL and the SUL. For a CG-based SDT, the RRC Release message may be used to reconfigure or release the CG-SDT configuration/resources while the UE is in the RRC_INACTIVE state.

For a CG-based SDT, the subsequent data transmission may use the CG resource or DG (e.g., dynamic grant addressed to UE's C-RNTI/CS-RNTI). The C-RNTI/CS-RNTI may be the same as the previous C-RNTI/CS-RNTI or may be configured explicitly by the network. For a CG-based SDT, a TA timer (e.g., cg-SDT-TimeAlignmentTimer) may be started upon receiving the TA configuration from a gNB, e.g., via an RRC release message, and may be (re)started upon reception of a TA command. For a CG-based SDT, the UE may release the CG configuration/resources when the TAT expires (e.g., while the UE is in the RRC_INACTIVE state). For an RA-based SDT, up to two preamble groups (e.g., corresponding to two different payload sizes for the MsgA/Msg3) may be configured by the network. For an RA-based SDT, upon a successful completion of the contention resolution, the UE may monitor the C-RNTI.

For an RA-based SDT, a RACH resource, e.g., (RO+preamble combination), may be different between an SDT (e.g., RA for SDT) and a non-SDT (e.g., RA for CCCH or RA for RRC connection resume). For an RA-based SDT, the RRC Release message may be sent at the end to terminate the SDT procedure (e.g., from RRC point of view). The RRC Release message sent at the end of the SDT may include the CG resource. An RSRP threshold (e.g., sdt-RSRP-Threshold) may be used to select between an SDT (e.g., initiate SDT procedure, initiate RA procedure for SDT, and/or initiate SDT procedure with CG) and a non-SDT procedure (e.g., initiate RA procedure for CCCH logical channel). For an SDT, the UE may perform UL carrier selection (e.g., UL and SUL selection).

If the CG-SDT resources are configured on the selected UL carrier and are valid, the CG-based SDT may be selected to perform. If the 2-step RA resources (e.g., for SDT) are configured on the UL carrier and criteria to select 2-step RA (e.g., for SDT) is met, the 2-step RA type (e.g., for SDT) may be selected. If 4-step RA resources (e.g., for SDT) are configured on the UL carrier and criteria to select 4-step RA (e.g., for SDT) is met, the 4-step RA type may be selected. The UE may not perform the SDT procedure (e.g., the UE may perform the RRC connection resume procedure). If both 2-step RA (e.g., for SDT) and 4-step RA resources (e.g., for SDT) are configured on the UL carrier, RA type selection (e.g., 2-step and 4-step RA type selection) may performed based on an RSRP threshold (e.g., sdt-MSGA-RSRP-Threshold).

In addition to the DRB, SRB1 and SRB2 may be configured for SDT (e.g., for carrying RRC and/or NAS messages). Upon initiating the SDT procedure and/or RRC resume procedure for SDT initiation (e.g., for the first SDT transmission), the UE may resume the SRB (e.g., SRB1, SRB2, and/or SRB3) that is configured for SDT (e.g., in addition to the SDT DRBs that are configured for SDT). A specific search space may be supported for monitoring the PDCCH addressed to the C-RNTI after a successful completion of the RACH procedure during the RA-SDT.

An RSRP threshold (e.g., sdt-RSRP-Threshold) may be used to select between an SDT and a non-SDT procedure, if configured (e.g., RSRP may refer to the same RSRP that is measured for carrier selection). An RSRP threshold (e.g., sdt-RSRP-Threshold) to select between an SDT and a non-SDT procedure may be used for both CG-SDT and RA-SDT. An RSRP threshold (e.g., sdt-RSRP-Threshold) to select between an SDT and a non-SDT procedure may be the same for both the CG-SDT and the RA-SDT. An RSRP threshold for carrier selection (e.g., sdt-RSRP-ThresholdSSB-SUL) may be specific to the SDT (e.g., separately configured for SDT). This may be optional for the network. An RSRP threshold for the RA type selection (e.g., sdt-MSGA-RSRP-Threshold) may be specific to the SDT (e.g., separately configured for SDT).

A Data volume threshold (e.g., sdt-DataVolumeThreshold) may be the same for the CG-SDT and the RA-SDT. Switching/fallback from the SDT procedure to the non-SDT procedure (e.g., an RRC connection resume procedure) may be applied based on some criteria. A switching/fallback from the CG-SDT to the RA-SDT may be applied based on some criteria. The UE may switch from the SDT procedure to the non-SDT procedure (e.g., an RRC connection resume procedure) in the following cases (a) and (b).

(a): UE receives indication from the network to switch to the non-SDT procedure. For example, the network may send an RRC Resume message, and/or may send an indication in the RAR/fallbackRAR/DCI to switch to the non-SDT procedure.

(b): Initial UL transmission (in MsgA/Msg3/CG resources) fails for a (configured) number of times.

The UE may perform a PDCP re-establishment implicitly (e.g., without explicit indication for the PDCP re-establishment), when the UE initiates the SDT procedure. The SR resource (e.g., a PUCCH resource for SR) may not be configured for SDT. When the BSR is triggered by SDT data, the UE may trigger an RA because the SR resource is not available. An SDT failure detection timer may be started upon initiation of the SDT procedure. Upon an SDT failure detection timer expiry, the UE may transition to an RRC_IDLE state and/or mat attempt an RRC connection setup. The CG resources for SDT may be configured at the same time on the NUL and SUL. The UE may start a timer after a UL transmission (e.g., for CG-SDT). The CG resources for SDT may be configured on the BWPs, other than the initial BWP. The CG resources per CG configuration may be associated with a set of SSB(s) configured by explicit signaling.

The specific search space may be a common search space to the UEs performing the RA-SDT. A UE-specific search space may be configured for the UEs that perform the CG-SDT. The UE may monitor the paging after the UE initiates an SDT for the system information change and/or for a Public Warning System (PWS). For a CG-based SDT, the SSB-to-PUSCH resource mapping within the CG configuration may be implicitly defined. The ordering of the SSB and CG PUSCH resources may be captured in RANI specification (e.g., as specified in 3GPP TS 38.213). A PUSCH resource may refer to a transmission occasion and a DMRS resource used for the PUSCH transmission.

The SSB subset for RSRP based TA validation may be determined at least based on a configured absolute RSRP threshold. The SSB subset may be (a) within a set of SSBs configured per CG configuration, (b) within a set of SSBs configured for all CG configurations, (c) within a set of all SSBs actually transmitted as indicated in SIB1, or (d) highest N SSBs that are measured to derive the subset for a UE across all CG configurations.

Data volume used for SDT selection criteria may be calculated as the total sum of Buffer Size across SDT RBs. For example, the UE may determine the amount of UL data available for a logical channel according to the data volume calculation procedure as specified in the 3GPP TS 38.322 and 3GPP TS 38.323.

Table 3 below shows an example of data volume calculation as specified in the 3GPP TS 38.322.

TABLE 3
For the purpose of MAC buffer status reporting, the UE shall consider the
following as RLC data volume:

| | |
|---|---|
| - | RLC SDUs and RLC SDU segments that have not yet been included |

in an RLC data PDU;

| | |
|---|---|
| - | RLC data PDUs that are pending for initial transmission; |
| - | RLC data PDUs that are pending for retransmission (RLC AM). |

Table 4 below shows an example of data volume calculation as specified in the 3GPP TS 38.323.

TABLE 4
For the purpose of MAC buffer status reporting, the transmitting PDCP

| | |
|---|---|
| | entity shall consider the following as PDCP data volume: |
| - | the PDCP SDUs for which no PDCP Data PDUs have been constructed; |
| - | the PDCP Data PDUs that have not been submitted to lower layers; |
| - | the PDCP Control PDUs; |
| - | for AM DRBs, the PDCP SDUs to be retransmitted; |
| - | for AM DRBs, the PDCP Data PDUs to be retransmitted. |

At initiation of an SDT procedure, the PDCP status report may not be triggered even if the RB is configured with statusReportRequired. The RRC layer may indicate to the PDCP layer to disable the PDCP status report, e.g., by de-configuring statusReportRequired (e.g., UE internally indicates). For an SDT procedure selection, same data volume threshold may be used for the CG-SDT and the RA-SDT. The BSR configuration used for the SDT may be different from the BSR configuration used in the RRC_CONNECTED state. The UE may perform an RLC re-establishment implicitly (e.g., without explicit indication for RLC re-establishment), when the UE initiates the SDT procedure.

During the SDT procedure, all the triggered PHRs may be cancelled if all the SDT data are included in the UL grant, and if there is no room in the MAC PDU to fit the PHR. The LCH restrictions may be applied, reusing existing signaling. The PDCP entities of only the non-SDT RBs may be re-established (e.g., not for the SDT RBs) when the UE transitions from the RRC_INACTIVE state, with an ongoing SDT session, to the RRC CONNECTED state. Events that trigger a termination or failure of an ongoing SDT session/procedure may be the following (a)-(c).

(a) A cell reselection.

(b) The expiry of the SDT failure detection timer.

(c) When the Max retx is reached in the RLC. The RLC AM max retransmission functionality may remain unchanged.

When a UE detects a failure of an ongoing SDT session/procedure, the UE may transition autonomously into the RRC_IDLE state. The SDT related RACH resources may be configured via the system information (e.g., SIB1). At least the following parameters (a)-(c) may be RA-SDT specific.

(a) SSB selection related parameters (e.g., rsrp-ThresholdSSB, msgA-RSRP-ThresholdSSB).

(b) Power control related parameters (e.g., preambleReceivedTargetPower/gA-PreambleReceivedTargetPower, powerRampingStep/msgA-PreamblePowerRampingStep, msg3-DeltaPreamble/msgA-DeltaPreamble).

(c) Preamble group related parameters (e.g., msg3-DeltaPreamble/msgA-DeltaPreamble, messagePowerOffsetGroupB for 2-step RA-SDT and 4-step RA-SDT).

For a shared ROs case, all the following configurations (a)-(c) may be allowed.

(a) 4-step RA-SDT shares ROs with 4-step RA and/or 2-step RA.

(b) 2-step RA-SDT shares ROs with 4-step RA and/or 2-step RA.

(c) 2-step RA-SDT shares ROs with 4-step RA-SDT and/or 4-step RA and/or 2-step RA.

For the RA-SDT preamble group selection, the UE may consider the SDT data size plus MAC subheader in addition to the CCCH SDU size plus MAC subheader and pathloss. The fallbackRAR reception as the legacy 2-step RACH may be supported in a 2-step RA-SDT (e.g., fallback from a 2-step RA-SDT to a 4-step RA-SDT when fallbackRAR is received). The UE may be configured to switch from the 2-step RA-SDT to the 4-step RA-SDT after N times of MsgA transmission. The PUCCH resources may be used for HARQ-ACK during the subsequent SDT transmissions (e.g., applicable for both RA and CG). The UE may suspend all the UL transmissions and may trigger a RACH if any UL transmission is needed when the TAT expires during an RA-SDT procedure. The RA-SDT may be configured on an initial BWP or a non-initial BWP. The UE may select any SSB if there is no qualified SSB for the RA-SDT, for example, similar to the legacy. If none of the SSBs' RSRPs is above the RSRP threshold of CG-SDT criteria in the type selection phase, the UE may select the RA-SDT if the RA-SDT criteria is met.

During a subsequent CG transmission phase (e.g., after the UE has received response from the NW), the UE may initiate at least a legacy RACH procedure (e.g., trigger due to no UL resources) based on one or more of the following conditions (a)-(c).

(a) no qualified SSB when the evaluation is performed.

(b) when TA is invalid.

(c) when SR is triggered due to lack of UL resource.

The UE may release a CG-SDT resource (e.g., if stored at the UE) when the UE initiates an RRC resume procedure from another cell which is different from the cell in which the RRC Release message is received. The C-RNTI previously configured in the RRC_CONNECTED state may be used for the UE to monitor the PDCCH in the CG-SDT. The CS-RNTI based dynamic retransmission mechanism may be reused for the CG-SDT. The CS-RNTI may be the same one as the one previously configured in the RRC_CONNECTED state or a new CS-RNTI provided to the UE.

During a subsequent new CG transmission phase, for the purpose of the CG resource selection, the UE may re-evaluate the SSB for the subsequent CG transmission. At least the following parameters (a)-(c) may be included in the CG-SDT configuration.

(a) The new TA timer in RRC_INACTIVE.

(b) The RSRP change threshold for TA validation mechanism in SDT (details dependent on RANI).

(c) The SSB RSRP threshold for beam selection (e.g., UE selects the beam and associated CG resource for data transmission).

Each N of consecutive SSB indexes associated with one CG configuration may be mapped to valid CG PUSCH resources. For example, in increasing order of DMRS resource indexes, where a DMRS resource index DMRSid is determined first in an ascending order of a DMRS port index and second in an ascending order of a DMRS sequence index. For example, in increasing order of the CG period indexes in the association period.

The mapping ratio N may be explicitly signaled and the association period may be implicitly derived. The SSB to CG PUSCH association period may be the duration of multiple CG periods depending on the smallest time duration in a set determined by the CG period, such that all SSBs associated with the CG configuration may be mapped at least once to the CG PUSCH resources. An association pattern period may include one or more association periods and may be determined so that a pattern between the CG PUSCH occasions and the SS/PBCH block indexes associated with the CG configuration may repeat at most every 640 msec.

The following PUSCH occasion validation rules may be applied for the CG-SDT. For an unpaired spectrum and for the SS/PBCH blocks with indexes provided by ssb-PositionsInBurst in SIB1 or by ServingCellConfigCommon, (a) if a UE is provided with the tdd-UL-DL-ConfigurationCommon, the valid PO may be the PO in the UL part in a slot, or at least Ngap symbols after the end of the DL part in a slot, or after the end of the SSB in a slot, (b) if a UE is not provided with the tdd-UL-DL-ConfigurationCommon, the valid PO may not precede an SS/PBCH block in the PUSCH slot, start at least Ngap symbols after the last SS/PBCH block symbol, (c) Ngap may be provided, for example, as specified in the 3GPP TS 38.213.

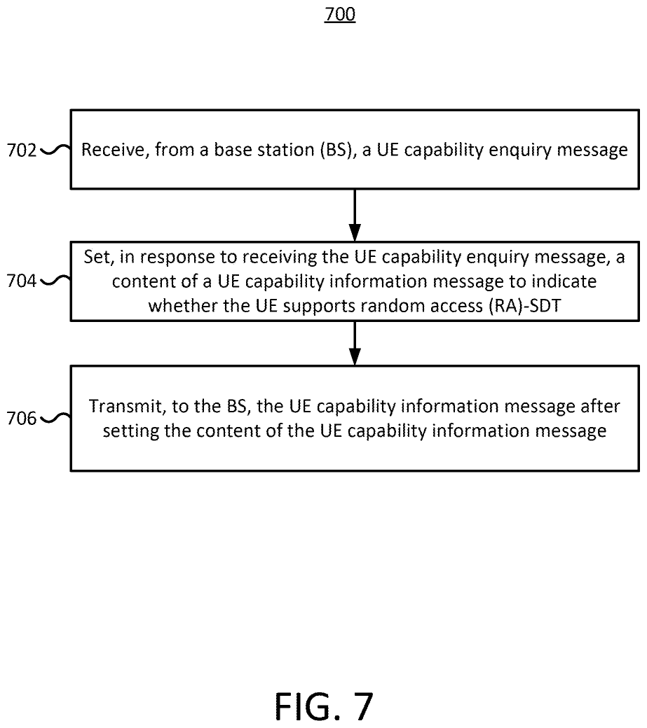

FIG. 7 is a flowchart illustrating a method 700 performed by a UE for reporting UE capability for small data transmission (SDT), according to an example implementation of the present disclosure. Although actions 702, 704, and 706 are illustrated as separate actions represented as independent blocks in FIG. 7, these separately illustrated actions should not be construed as necessarily order-dependent. The order in which the actions are performed in FIG. 7 is not intended to be construed as a limitation, and any number of the disclosed blocks may be combined in any order to implement the method, or an alternate method. Moreover, each of actions 702, 704, and 706 may be performed independently of other actions and can be omitted in some implementations of the present disclosure.

In action 702, the UE may receive, from a base station (BS), a UE capability enquiry message.

In action 704, the UE may set, in response to receiving the UE capability enquiry message, a content of a UE capability information message to indicate whether the UE supports random access (RA)-SDT. In some implementations, the RA-SDT may be used for a transmission of data or signaling over allowed radio bearers via an RA procedure, while the UE is in a radio resource control (RRC) INACTIVE state.

In action 706, the UE may transmit, to the BS, the UE capability information message after setting the content of the UE capability information message. In some implementations, a radio resource control (RRC) layer of the UE may submit the UE capability information message to a lower layer of the UE for transmission.

In some implementations, the UE may set the content of the UE capability information message to further indicate whether the UE supports configured grant (CG)-SDT. In some implementations, the CG-SDT may be used for a transmission of data or signaling over allowed radio bearers via CG type 1, while the UE is in a radio resource control (RRC) INACTIVE state. In some implementations, the UE may set the content of the UE capability information message to further indicate whether the UE supports up to a maximum number of active CG configurations. In some implementations, the UE may set the content of the UE capability information message to further indicate the UE supports multiple CG-SDT configurations in a case that the UE supports the CG-SDT and the UE supports up to the maximum number of the active CG configurations.

The SDT procedure may be configured to either take place on the RACH (e.g., RA-based SDT) (configured via system information) or type 1 CG resources (e.g., CG-based SDT) (configured via dedicated signaling in RRC Release message). To avoid the resource inefficiency problem, RACH and CG resources for SDT may only be configured to UEs supporting RA-SDT (CG-SDT). To this purpose, the network may need to know whether a UE supports RA-SDT (CG-SDT) or not. In the present disclosure, we propose a method performed by a UE for reporting UE capability for SDT so that the network can efficiently configure SDT resources based on the information of UE capability reporting.

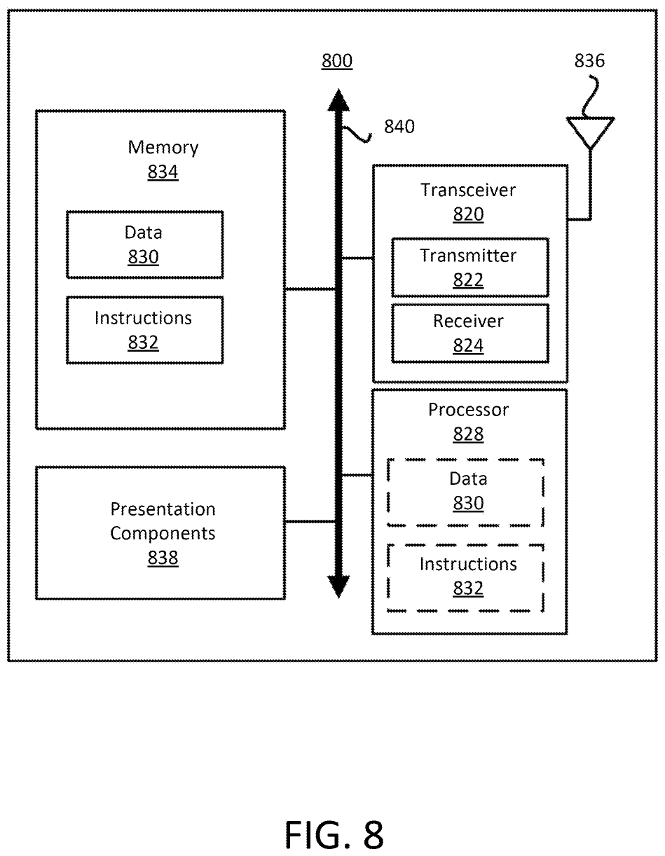

FIG. 8 is a block diagram illustrating a node 800 for wireless communication, according to an example implementation of the present disclosure. As illustrated in FIG. 8, a node 800 may include a transceiver 820, a processor 828, a memory 834, one or more presentation components 838, and at least one antenna 836. The node 800 may also include a radio frequency (RF) spectrum band module, a BS communications module, a network communications module, and a system communications management module, Input/Output (I/O) ports, I/O components, and a power supply (not illustrated in FIG. 8).

Each of the components may directly or indirectly communicate with each other over one or more buses 840. The node 800 may be a UE or a BS that performs various functions disclosed with reference to FIGS. 1-7.

The transceiver 820 has a transmitter 822 (e.g., transmitting/transmission circuitry) and a receiver 824 (e.g., receiving/reception circuitry) and may be configured to transmit and/or receive time and/or frequency resource partitioning information. The transceiver 820 may be configured to transmit in different types of subframes and slots including but not limited to usable, non-usable, and flexibly usable subframes and slot formats. The transceiver 820 may be configured to receive data and control channels.

The node 800 may include a variety of computer-readable media. Computer-readable media may be any available media that may be accessed by the node 800 and include volatile (and/or non-volatile) media and removable (and/or non-removable) media.

The computer-readable media may include computer-storage media and communication media. Computer-storage media may include both volatile (and/or non-volatile media), and removable (and/or non-removable) media implemented in any method or technology for storage of information such as computer-readable instructions, data structures, program modules or data.

Computer-storage media may include RAM, ROM, EPROM, EEPROM, flash memory (or other memory technology), CD-ROM, Digital Versatile Disks (DVD) (or other optical disk storage), magnetic cassettes, magnetic tape, magnetic disk storage (or other magnetic storage devices), etc. Computer-storage media may not include a propagated data signal. Communication media may typically embody computer-readable instructions, data structures, program modules or other data in a modulated data signal such as a carrier wave or other transport mechanisms and include any information delivery media.

The term “modulated data signal” may mean a signal that has one or more of its characteristics set or changed in such a manner as to encode information in the signal. Communication media may include wired media such as a wired network or direct-wired connection, and wireless media such as acoustic, RF, infrared, and other wireless media. Combinations of any of the previously listed components should also be included within the scope of computer-readable media.

The memory 834 may include computer-storage media in the form of volatile and/or non-volatile memory. The memory 834 may be removable, non-removable, or a combination thereof. Example memory may include solid-state memory, hard drives, optical-disc drives, etc. As illustrated in FIG. 8, the memory 834 may store a computer-readable and/or computer-executable program 832 (e.g., software codes) that are configured to, when executed, cause the processor 828 to perform various functions disclosed herein, for example, with reference to FIG. 7. Alternatively, the program 832 may not be directly executable by the processor 828 but may be configured to cause the node 800 (e.g., when compiled and executed) to perform various functions disclosed herein.

The processor 828 (e.g., having processing circuitry) may include an intelligent hardware device (e.g., a Central Processing Unit (CPU), a microcontroller, an ASIC, etc). The processor 828 may include memory. The processor 828 may process the data 830 and the program 832 received from the memory 834, and information transmitted and received via the transceiver 820, the base band communications module, and/or the network communications module. The processor 828 may also process information to send to the transceiver 820 for transmission via the antenna 836 to the network communications module for transmission to a CN.

One or more presentation components 838 may present data indications to a person or another device. Examples of presentation components 838 may include a display device, a speaker, a printing component, a vibrating component, etc.

In view of the present disclosure, it is obvious that various techniques may be used for implementing the disclosed concepts without departing from the scope of those concepts. Moreover, while the concepts have been disclosed with specific reference to certain implementations, a person of ordinary skill in the art may recognize that changes may be made in form and detail without departing from the scope of those concepts. As such, the disclosed implementations are to be considered in all respects as illustrative and not restrictive. It should also be understood that the present disclosure is not limited to the particular implementations disclosed and many rearrangements, modifications, and substitutions are possible without departing from the scope of the present disclosure.

What is claimed is:

1. A method performed by a user equipment (UE) for reporting UE capability for small data transmission (SDT), the method comprising:
receiving, from a base station (BS), a UE capability enquiry message;
setting, in response to receiving the UE capability enquiry message, a content of a UE capability information message to indicate whether the UE supports random access (RA)-SDT; and
transmitting, to the BS, the UE capability information message after setting the content of the UE capability information message.

2. The method of claim 1, wherein the RA-SDT is used for a transmission of data or signaling over allowed radio bearers via an RA procedure, while the UE is in a radio resource control (RRC)_INACTIVE state.

3. The method of claim 1, further comprising:
setting the content of the UE capability information message to further indicate whether the UE supports configured grant (CG)-SDT.

4. The method of claim 3, wherein the CG-SDT is used for a transmission of data or signaling over allowed radio bearers via a CG type 1, while the UE is in a radio resource control (RRC)_INACTIVE state.

5. The method of claim 3, further comprising:
setting the content of the UE capability information message to further indicate whether the UE supports up to a maximum number of active CG configurations.

6. The method of claim 5, further comprising:
setting the content of the UE capability information message to further indicate the UE supports multiple CG-SDT configurations in a case that the UE supports the CG-SDT and the UE supports up to the maximum number of the active CG configurations.

7. The method of claim 1, further comprising:
submitting, by a radio resource control (RRC) layer of the UE, the UE capability information message to a lower layer of the UE for transmission.

8. A user equipment (UE) for reporting UE capability for small data transmission (SDT), the UE comprising:
one or more non-transitory computer-readable media having computer-executable instructions embodied thereon; and
at least one processor coupled to the one or more non-transitory computer-readable media, the at least one processor configured to execute the computer-executable instructions to:
receive, from a base station (BS), a UE capability enquiry message,
set, in response to receiving the UE capability enquiry message, a content of a UE capability information message to indicate whether the UE supports random access (RA)-SDT, and
transmit, to the BS, the UE capability information message after setting the content of the UE capability information message.

9. The UE of claim 8, wherein the RA-SDT is used for a transmission of data or signaling over allowed radio bearers via an RA procedure, while the UE is in a radio resource control (RRC)_INACTIVE state.

10. The UE of claim 8, wherein the at least one processor is further configured to execute the computer-executable instructions to:
set the content of the UE capability information message to further indicate whether the UE supports configured grant (CG)-SDT.

11. The UE of claim 10, wherein the CG-SDT is used for a transmission of data or signaling over allowed radio bearers via CG type 1, while the UE is in a radio resource control (RRC)_INACTIVE state.

12. The UE of claim 10, wherein the at least one processor is further configured to execute the computer-executable instructions to:
set the content of the UE capability information message to further indicate whether the UE supports up to a maximum number of active CG configurations.

13. The UE of claim 12, wherein the at least one processor is further configured to execute the computer-executable instructions to:
set the content of the UE capability information message to indicate the UE supports multiple CG-SDT configurations in a case that the UE supports the CG-SDT and the UE supports up to the maximum number of the active CG configurations.

14. The UE of claim 8, wherein the at least one processor is further configured to execute the computer-executable instructions to:
submit, by a radio resource control (RRC) layer of the UE, the UE capability information message to a lower layer of the UE for transmission.
